(19) United States
(12) Patent Application Publication
(10) Pub. No.: US 2025/0167359 A1
(43) Pub. Date: May 22, 2025

(54) SECONDARY BATTERY

(71) Applicant: SEMICONDUCTOR ENERGY LABORATORY CO., LTD., Atsugi-shi, Kanagawa-ken (JP)

(72) Inventors: Yosiharu ASADA, Odawara, Kanagawa (JP); Kazutaka KURIKI, Ebina, Kanagawa (JP); Yumiko YONEDA, Isehara, Kanagawa (JP); Harushi ITO, Atsugi, Kanagawa (JP)

(21) Appl. No.: 18/838,429

(22) PCT Filed: Feb. 3, 2023
(86) PCT No.: PCT/IB2023/050942

§ 371 Date: Aug. 14, 2024

(30) Foreign Application Priority Data
Feb. 18, 2022 (JP) 2022-023590

(51) Int. Cl. H01M 50/178; H01M 10/0585; H01M 50/105; H01M 50/121

(52) U.S. Cl. CPC H01M 50/178; H01M 10/0585; H01M 50/105; H01M 50/121

(57) ABSTRACT

A secondary battery that can inhibit deterioration of an electrode is provided. A flexible secondary battery is provided. The secondary battery includes a positive electrode, a negative electrode, a separator, a first spacer, a second spacer, a positive electrode lead, a negative electrode lead, and an exterior body. The positive electrode includes a first portion coated with a positive electrode active material and a second portion where a positive electrode current collector is exposed. The negative electrode includes a third portion coated with a negative electrode active material and a fourth portion where a negative electrode current collector is exposed. The first portion, the third portion, and the separator overlap with each other in a stacked portion. The positive electrode lead is connected to the second portion in a position overlapping with the stacked portion. The negative electrode lead is connected to the fourth portion in a position overlapping with the stacked portion. The first spacer is in contact with the exterior body in a region surrounded by one end portion of the stacked portion, the positive electrode lead, and the negative electrode lead. The second spacer includes a region interposed between the stacked portion and the second portion, a region interposed between the stacked portion and the fourth portion, and a region connected to the first spacer.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification refers to all devices including power storage devices, and electro-optical devices including power storage devices, information terminal devices including power storage devices, and the like are all electronic devices.

Note that in this specification, a power storage device refers to all elements and devices each having a function of storing power, and for example, a power storage device (also referred to as a secondary battery) such as a lithium-ion secondary battery, a lithium-ion capacitor, and an electric double layer capacitor are included therein.

### BACKGROUND ART

As secondary batteries, a variety of power storage devices such as lithium-ion secondary batteries, lithium-ion capacitors, and air batteries have been actively developed. In particular, lithium-ion secondary batteries with high output and high energy density are mounted on portable information terminals such as mobile phones, smartphones, tablets, and laptop computers; portable music players; digital cameras; medical equipment; clean energy vehicles (e.g., hybrid vehicles (HVs), electric vehicles (EVs), and plug-in hybrid vehicles (PHVs); agricultural machines; motorized bicycles including motor-assisted bicycles; motorcycles; electric wheelchairs; electric carts; ships; submarines; aircraft; rockets; artificial satellites; space probes; planetary probes; spacecraft; and the like. Thus, demand for lithium-ion secondary batteries has rapidly grown with the development of the semiconductor industry, and the lithium-ion secondary batteries are essential as rechargeable energy supply sources for the current information society.

In recent years, wearable devices have been actively developed. Since wearable devices are worn on one's body, they preferably have curved shapes along a curved surface of the body or they are preferably curved according to the movement of the body. Thus, not only displays and other housings but also secondary batteries mounted in wearable devices preferably have flexibility.

Secondary batteries mounted in devices other than the wearable devices also preferably have flexibility because the space inside the devices can be used more efficiently when the secondary batteries can be changed in shape.

For example, Patent Document 1 discloses as a flexible secondary battery an electrochemical device (e.g., a secondary battery or a capacitor) which is covered with a metal laminate and which can be easily curved or can easily maintain a curved state.

### REFERENCES

### Patent Documents

[Patent Document 1] Japanese Published Patent Application No. 2004-241250
[Patent Document 2] Japanese Published Patent Application No. 2018-6336

### SUMMARY OF THE INVENTION

### Problems to be Solved by the Invention

A secondary battery having flexibility includes an exterior body formed using a flexible material such as a laminated film, and is provided with a positive electrode lead and a negative electrode lead to take a positive electrode and a negative electrode out from the exterior body. Here, the positive electrode lead and the negative electrode lead are sandwiched by the exterior body and fixed. The positive electrode lead is connected to a positive electrode tab (part of a positive electrode current collector) provided in the positive electrode, and the negative electrode lead is connected to a negative electrode tab (part of a negative electrode current collector) provided in the negative electrode. The positive electrode tab and the negative electrode tab have shapes in which part of the current collector in each electrode protrudes. Thus, the positive electrode tab and the negative electrode tab are likely to cause degradation such as a crack or a breakage compared with main portions of the electrodes.

In particular, in the case where the positive electrode lead and the negative electrode lead are each connected to a side of an end portion in a curved direction of the secondary battery as disclosed in Patent Document 1, stress due to change in shape of the secondary battery tends to concentrate on a positive electrode lead connection portion and a negative electrode lead connection portion. Thus, the positive electrode lead connection portion and the negative electrode lead connection portion might be cracked or broken when an electronic device including the secondary battery is changed in shape (e.g., bent and stretched) repeatedly, for example.

Against such problems, for example, a secondary battery having an internal structure for reducing stress applied to a lead connection portion due to change in shape of the secondary battery has been studied as disclosed in Patent Document 2. However, there is room for improvement in the internal structure of the secondary battery, the method for manufacturing the secondary battery, and the like.

For example, in the case where an exterior body with low rigidity is used to increase the flexibility of the secondary battery, change in shape of the exterior body in change in shape of the secondary battery is large; thus, a space for change in shape of the internal structure of the secondary battery is small. Therefore, there is some risk that stress due to change in shape might be likely to be concentrated on the positive electrode lead connection portion and the negative electrode lead connection portion.

In the case where a secondary battery having flexibility is used in a low-pressure environment such as outer space, in order to solve a problem such as volume expansion of the secondary battery due to a difference in the pressure from the fabrication environment of the secondary battery, the secondary battery is sometimes fabricated using an electrolyte containing an ionic liquid in a low-pressure environment (also referred to as a reduced-pressure environment). Specifically, the exterior body of the secondary battery is sealed in a low-pressure environment of 1000 Pa or lower in some cases. In the case where the secondary battery fabricated in such a manner is curved in an atmospheric pressure environment, there is some risk that the space for change in shape of the internal structure of the secondary battery is small. Therefore, stress due to change in shape is likely to be concentrated on the positive electrode lead connection portion and the negative electrode lead connection portion.

In view of the above problems, an object of one embodiment of the present invention is to provide a secondary battery with a structure that can inhibit degradation of a positive electrode or a negative electrode, in particular, a positive electrode lead connection portion or a negative electrode lead connection portion.

Another object of one embodiment of the present invention is to provide a method for manufacturing a secondary battery with a structure that can inhibit degradation of a positive electrode or a negative electrode, in particular, a positive electrode lead connection portion or a negative electrode lead connection portion.

Another object of one embodiment of the present invention is to provide a secondary battery with a novel structure. Specifically, an object is to provide a flexible secondary battery with a novel structure. Another object of one embodiment of the present invention is to provide a novel power storage device, an electronic device including a novel secondary battery, or the like.

Note that the description of these objects does not preclude the existence of other objects. In one embodiment of the present invention, there is no need to achieve all of these objects. Note that other objects will be apparent from the description of the specification, the drawings, the claims, and the like, and other objects can be derived from the description of the specification, the drawings, the claims, and the like.

### Means for Solving the Problems

To achieve the above objects, one embodiment of the present invention has a structure in which a secondary battery can be curved with reduced stress applied to a positive electrode lead connection portion or a negative electrode lead connection portion.

One embodiment of the present invention is a secondary battery including an exterior body enclosing a positive electrode, a negative electrode, a separator, a first spacer, and a second spacer, and a positive electrode lead and a negative electrode lead that extend from the inside to the outside of a space enclosed by the exterior body. The positive electrode includes a first portion coated with a positive electrode active material and a second portion where a positive electrode current collector is exposed. The negative electrode includes a third portion coated with a negative electrode active material and a fourth portion where a negative electrode current collector is exposed. The first portion, the third portion, and the separator overlap with each other in a stacked portion. The positive electrode lead is connected to the second portion in a position overlapping with the stacked portion. The negative electrode lead is connected to the fourth portion in a position overlapping with the stacked portion. The first spacer is in contact with the exterior body in a region surrounded by one end portion of the stacked portion, the positive electrode lead, and the negative electrode lead in the top view. The second spacer includes a region interposed between the stacked portion and the second portion, a region interposed between the stacked portion and the fourth portion, and a region connected to the first spacer.

In the above secondary battery, the height of the first spacer is preferably greater than or equal to the sum of the height of the stacked portion, the height of the second spacer, the height of the second portion, and the height of the positive electrode lead.

In the above secondary battery, the height of the first spacer is preferably greater than or equal to the sum of the height of the stacked portion, the height of the second spacer, the height of the fourth portion, and the height of the negative electrode lead.

In the above secondary battery, the second portion preferably includes a curved portion between a connection portion for the positive electrode lead and the stacked portion, and the curved portion preferably includes a region in contact with the second spacer.

In the above secondary battery, the fourth portion preferably includes a curved portion between a connection portion for the negative electrode lead and the stacked portion, and the curved portion preferably includes a region in contact with the second spacer.

In the above secondary battery, the first spacer and the second spacer are preferably flexible, and the first spacer is preferably more elastic than the second spacer.

In the above secondary battery, the exterior body preferably includes a region in contact with a flexible film on the inner surface of the space enclosed by the exterior body, and the stacked portion preferably includes a region in contact with the flexible film in the other end portion of the stacked portion.

In the above secondary battery, the flexible film preferably is insulative.

In the above secondary battery, the flexible film preferably contains polyimide and includes a region where the other end portion of the stack portion is in contact with the polyimide.

In any one of the above secondary batteries, the exterior body preferably includes a depression and a projection.

### Effect of the Invention

One embodiment of the present invention can provide a secondary battery with a structure that can inhibit degradation of a positive electrode or a negative electrode, in particular, a positive electrode lead connection portion or a negative electrode lead connection portion.

Another embodiment of the present invention can provide a method for manufacturing a secondary battery with a structure that can inhibit degradation of a positive electrode or a negative electrode, in particular, a positive electrode lead connection portion or a negative electrode lead connection portion.

Another embodiment of the present invention can provide a secondary battery with a novel structure. More specifically, a flexible secondary battery with a novel structure can be provided. Another embodiment of the present invention can provide a novel power storage device, an electronic device including a novel secondary battery, or the like.

Note that the description of these effects does not preclude the existence of other effects. One embodiment of the present invention does not necessarily have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are perspective views illustrating a structure example of a secondary battery.

FIG. 2A is a top view illustrating a structure example of a secondary battery, and FIG. 2B and FIG. 2C are cross-sectional views illustrating a structure example of the secondary battery.

FIG. 3A is a top view illustrating a structure example of a secondary battery, and FIG. 3B to FIG. 3D are cross-sectional views illustrating structure examples of the secondary battery.

FIG. 4A is a top view illustrating a structure example of a secondary battery, and FIG. 4B to FIG. 4D are cross-sectional views illustrating structure examples of the secondary battery.

FIG. 5A to FIG. 5C are cross-sectional views illustrating a structure example of a secondary battery.

FIG. 6A and FIG. 6B are cross-sectional views illustrating a structure example of a secondary battery.

FIG. 7A to FIG. 7C are perspective views illustrating a manufacturing example of a secondary battery.

FIG. 8A to FIG. 8C are perspective views illustrating a manufacturing example of a secondary battery.

FIG. 9A and FIG. 9B are perspective views each illustrating a manufacturing example of a secondary battery.

FIG. 10 is a perspective view illustrating a manufacturing example of a secondary battery.

FIG. 11 is a diagram illustrating a processing method of a film.

FIG. 12A to FIG. 12E are diagrams each illustrating a processing method of a film.

FIG. 13A and FIG. 13B are diagrams each illustrating a processing method of a film.

FIG. 14A and FIG. 14B are diagrams illustrating an electronic device of one embodiment of the present invention.

FIG. 15A and FIG. 15B are diagrams illustrating an electronic device of one embodiment of the present invention.

FIG. 16A to FIG. 16D are diagrams each illustrating an electronic device of one embodiment of the present invention.

FIG. 17A to FIG. 17D are diagrams each illustrating an electronic device of one embodiment of the present invention.

FIG. 18A to FIG. 18C are diagrams illustrating an electronic device of one embodiment of the present invention.

FIG. 19A to FIG. 19C are diagrams illustrating an electronic device of one embodiment of the present invention.

FIG. 20A is a perspective view illustrating an example of a battery pack. FIG. 20B is a block diagram illustrating an example of a battery pack. FIG. 20C is a block diagram illustrating an example of a vehicle including a motor.

FIG. 21A to FIG. 21E are diagrams each illustrating an example of a transport vehicle.

FIG. 22A is a diagram illustrating an electric bicycle, FIG. 22B is a diagram illustrating a secondary battery of an electric bicycle, and FIG. 22C is a diagram illustrating an electric motorcycle.

FIG. 23A and FIG. 23B are diagrams each illustrating an example of a power storage device.

FIG. 24A to FIG. 24D are diagrams each illustrating an example of a device for space.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

The term “electrically connected” includes the case where components are connected through an “object having any electric function”. There is no particular limitation on the “object having any electric function” as long as electric signals can be transmitted and received between the components connected through the object.

The position, size, range, or the like of each component illustrated in drawings and the like is not accurately represented in some cases for easy understanding. Therefore, the disclosed invention is not necessarily limited to the position, size, range, or the like disclosed in the drawings and the like.

Ordinal numbers such as “first”, “second”, and “third” are used to avoid confusion among components.

In this specification, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°.

In this specification, “perpendicular” indicates a state where two straight lines are placed at an angle greater than or equal to 80° and less than or equal to 100°. Thus, the case where the angle is greater than or equal to 85° and less than or equal to 95° is also included. Furthermore, “approximately perpendicular” or “substantially perpendicular” indicates a state where two straight lines are placed at an angle greater than or equal to 60° and less than or equal to 120°.

The particle diameter of a particle can be measured by, for example, laser diffraction particle size distribution measurement and can be represented as D50. D50 is a particle diameter when the accumulated amount of particles accounts for 50% of an accumulated particle amount curve which is the result of the particle size distribution measurement, i.e., a median diameter. The measurement of the particle diameter of a particle is not limited to laser diffraction particle size distribution measurement; in the case where the particle diameter of a particle is less than or equal to the lower measurement limit of laser diffraction particle size distribution measurement, the cross-sectional diameter of the particle may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

Note that in the drawings illustrating the present invention, some structures (e.g., the ratio between the size and the thickness of an electrode) are exaggerated for easy understanding in some cases. Furthermore, some components are not illustrated in some cases to avoid complexity of the drawings.

### Embodiment 1

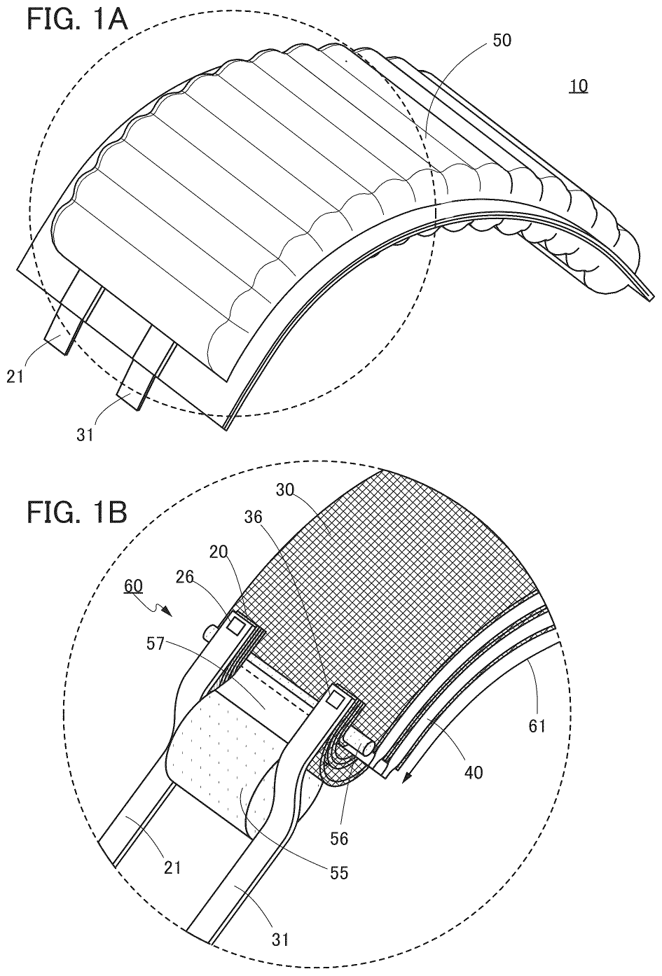

In this embodiment, structure examples of a flexible secondary battery (sometimes referred to as a flexible battery, a curved battery, or a bendable battery) of one embodiment of the present invention will be described with reference to FIG. 1 to FIG. 6.

### [Secondary Battery]

FIG. 1A to FIG. 5C are schematic views illustrating a secondary battery 10 of one embodiment of the present invention. FIG. 1A is a perspective view of the secondary battery 10. FIG. 1B is a perspective view illustrating an internal structure of the secondary battery 10 in the dashed line portion in FIG. 1A.

FIG. 1A is a schematic view of the flexible secondary battery 10, which illustrate a state where the secondary battery 10 is curved in one direction. The secondary battery 10 includes an exterior body 50, and a positive electrode lead 21 and a negative electrode lead 31 which extend from the inside to the outside of a space enclosed by the exterior body 50.

FIG. 1B illustrates the internal structure of the secondary battery 10 in the dashed line portion in FIG. 1A. The secondary battery 10 includes a stack 60 therein. The stack 60 includes a positive electrode 20, a negative electrode 30, a separator 40, the positive electrode lead 21, the negative electrode lead 31, a first spacer 55, and a second spacer 56.

As illustrated in FIG. 1B, the stack 60 includes a stacked portion 61 in which the positive electrode 20, the negative electrode 30, and the separator 40 are stacked, and part of the positive electrode 20 protruding from the stacked portion 61 is connected to the positive electrode lead 21 at a connection portion 26 positioned to overlap with the stacked portion 61. Part of the negative electrode 30 protruding from the stacked portion 61 is connected to the negative electrode lead 31 at a connection portion 36 positioned to overlap with the stacked portion 61.

The first spacer 55 included in the stack 60 is positioned in a region surrounded by the stacked portion 61, the positive electrode lead 21, and the negative electrode lead 31. The second spacer 56 includes a first region sandwiched between the connection portion 26 and the stacked portion 61 and a second region sandwiched between the connection portion 36 and the stacked portion 61. The second spacer 56 includes a region connected to the first spacer 55 through a connection portion 57 in a position between the first region and the second region.

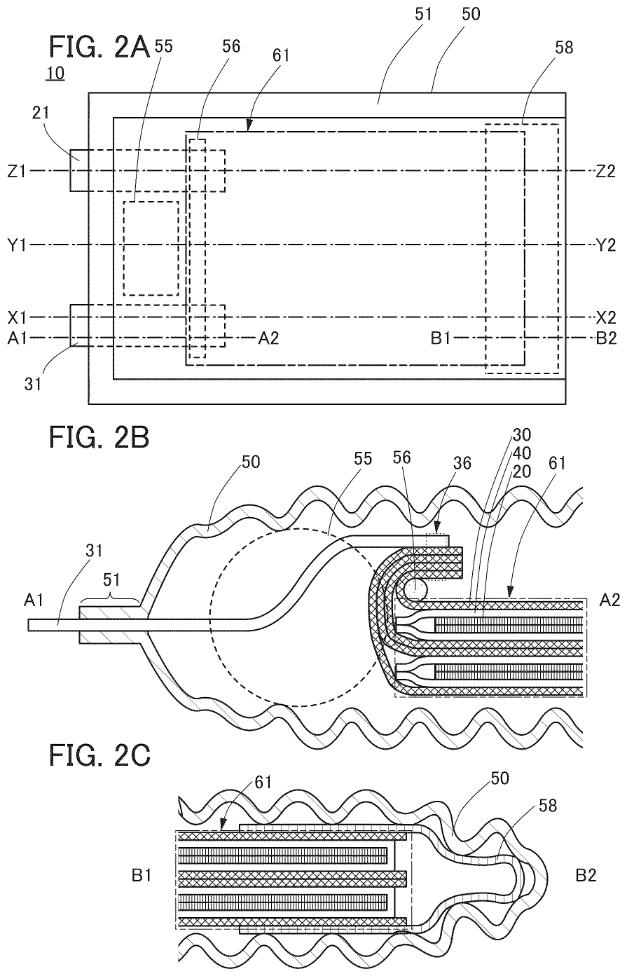

FIG. 2A is a top view of the secondary battery 10, FIG. 2B is a cross-sectional view illustrating a cross section cut along a dashed-dotted line A1-A2 in FIG. 2A, and FIG. 2C is a cross-sectional view illustrating a cross section cut along a dashed-dotted line B1-B2 in FIG. 2A.

The secondary battery 10 illustrated in FIG. 2A includes the exterior body 50 and a sealing portion 51 of the exterior body 50. Here, an example in which one side of the exterior body 50 is folded and the other three sides are provided with the sealing portion 51 is illustrated. Such sealing is referred to as three-side sealing in some cases. Note that a four-side sealing structure in which four sides of the exterior body are sealed may be employed.

As illustrated in FIG. 2A, it can be said that the first spacer 55 is positioned in a region surrounded by the stacked portion 61, the positive electrode lead 21, the negative electrode lead 31, and the sealing portion 51 in the top view. The region is also referred to as a region including the first spacer 55.

One end portion of the stacked portion 61 is in contact with the region including the first spacer 55, and the other end portion thereof includes a region in contact with a flexible film 58.

FIG. 2B is a cross-sectional view illustrating a cross section cut along the dashed-dotted line A1-A2 in FIG. 2A. As illustrated in FIG. 2B, the sealing portion 51 of the exterior body 50 includes a region sealed with the negative electrode lead 31 interposed therebetween. Although not illustrated, the sealing portion 51 of the exterior body 50 includes a region sealed with the positive electrode lead 21 interposed therebetween, as in FIG. 2B. In this manner, the positive electrode lead 21 and the negative electrode lead 31 extend from the inside to the outside of the exterior body 50.

Inside the exterior body 50, the negative electrode lead 31 and the negative electrode 30 are connected to each other at the connection portion 36 as illustrated in FIG. 2B. Here, the negative electrode 30 does not include an active material layer in the connection portion 36 and both surfaces of a negative electrode current collector are exposed; thus, a plurality of negative electrodes 30 and the negative electrode lead 31 can be connected to each other. The negative electrode 30 includes a negative electrode active material layer in the stacked portion 61.

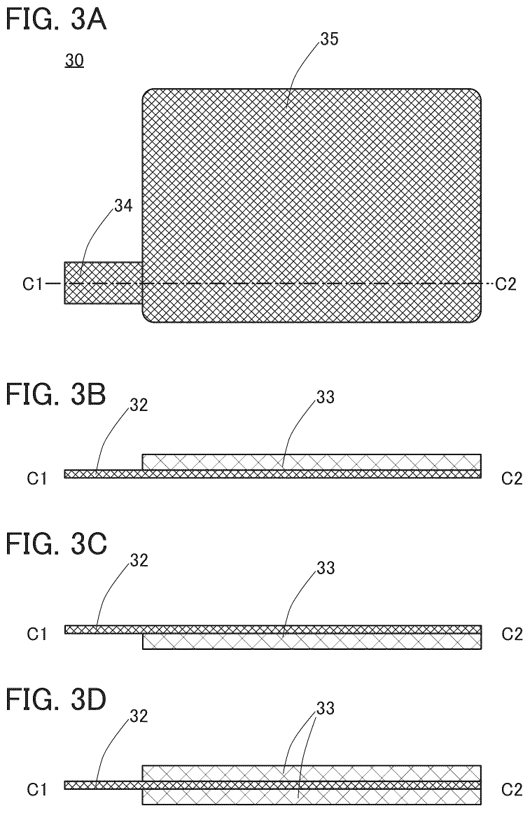

The negative electrode 30 is described with reference to FIG. 3A to FIG. 3C. FIG. 3A is a top view of the negative electrode 30, and FIG. 3B and FIG. 3C are cross-sectional views each illustrating the negative electrode 30.

As illustrated in FIG. 3A, the negative electrode 30 includes a negative electrode current collector exposed portion 34 and a negative electrode active material coated portion 35.

FIG. 3B is a cross-sectional view taken along a dashed-dotted line C1-C2 in FIG. 3A. The negative electrode 30 includes a negative electrode active material layer 33 over a negative electrode current collector 32 in the negative electrode active material coated portion 35. In the negative electrode current collector exposed portion 34, both surfaces of the negative electrode current collector 32 are exposed. Note that FIG. 3C illustrates an example in which the negative electrode active material layer 33 is provided in a position different from that in FIG. 3B. In the cross-sectional view illustrated in FIG. 2B, the negative electrode 30 illustrated in FIG. 3B and FIG. 3C can be used as the negative electrode 30. Note that the negative electrode current collector exposed portion 34 refers to a region where both surfaces of the negative electrode current collector 32 are exposed, and is not the back surface (the opposite surface) or the side surface of the negative electrode current collector 32 in the region where the negative electrode active material layer 33 is provided. The negative electrode current collector exposed portion 34 is also called so even when in contact with an electrolyte inside the secondary battery.

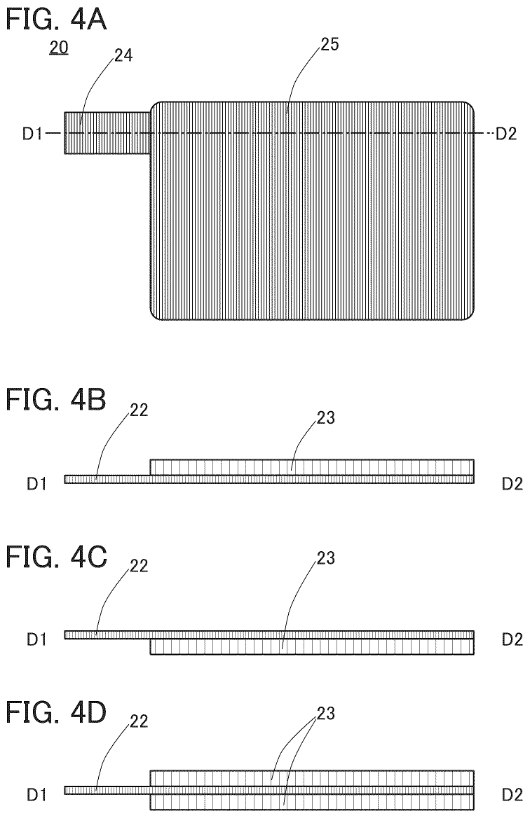

The positive electrode 20 is described with reference to FIG. 4A to FIG. 4C. FIG. 4A is a top view of the positive electrode 20, and FIG. 4B and FIG. 4C are cross-sectional views each illustrating the positive electrode 20.

As illustrated in FIG. 4A, the positive electrode 20 includes a positive electrode current collector exposed portion 24 and a positive electrode active material coated portion 25.

FIG. 4B is a cross-sectional view taken along a dashed-dotted line D1-D2 in FIG. 4A. The positive electrode 20 includes a positive electrode active material layer 23 over a positive electrode current collector 22 in the positive electrode active material coated portion 25. In the positive electrode current collector exposed portion 24, both surfaces of the positive electrode current collector 22 are exposed. Note that FIG. 4C illustrates an example in which the positive electrode active material layer 23 is provided in a position different from that in FIG. 4B. In the cross-sectional view illustrated in FIG. 2B, the positive electrode 20 illustrated in FIG. 4B and FIG. 4C can be used as the positive electrode 20. Note that the positive electrode current collector exposed portion 24 refers to a region where both surfaces of the positive electrode current collector 22 are exposed, and is not the back surface (the opposite surface) or the side surface of the positive electrode current collector 22 in the region where the positive electrode active material layer 23 is provided. The positive electrode current collector exposed portion 24 is also called so even when in contact with an electrolyte inside the secondary battery.

As illustrated in FIG. 2B, the positive electrode 20, the negative electrode 30, and the separator 40 are stacked in the stacked portion 61. At this time, the positive electrode active material layer 23 included in the positive electrode 20 and the negative electrode active material layer 33 included in the negative electrode 30 are stacked so as to face each other with the separator 40 interposed therebetween. In the cross-sectional view illustrated in FIG. 2B, an example in which each of the positive electrode 20 and the negative electrode 30 is a single-side-coated electrode including the active material layer on one side of the current collector is illustrated.

Note that the stacked portion 61 refers to a portion where the positive electrode active material coated portion 25, the negative electrode active material coated portion 35, and the separator are stacked. In other words, the positive electrode active material coated portion 25, the negative electrode active material coated portion 35, and the separator overlap with each other in the stacked portion. The positive electrode current collector exposed portion 24 and the negative electrode current collector exposed portion 34 are sometimes referred to as protruding portions of the stacked portion 61.

Since the first spacer 55 does not exist in the cross section illustrated in FIG. 2B, the position of the first spacer 55 is denoted by a dashed line. As illustrated in FIG. 2B, the first spacer 55 includes a region in contact with the exterior body 50. In other words, the first spacer 55 is in contact with the exterior body 50 at a position surrounded by the stacked portion 61, the positive electrode lead 21, the negative electrode lead 31, and the sealing portion 51.

As illustrated in FIG. 2B, the second spacer 56 is provided at a position sandwiched between the stacked portion 61 and the negative electrode current collector exposed portion 34.

As will be described in detail later, with the first spacer 55 and the second spacer 56 illustrated in FIG. 2B and the like, stress applied to the connection portion 26 for connecting the positive electrode lead and/or the connection portion 36 for connecting the negative electrode lead when the secondary battery 10 is curved can be reduced.

FIG. 2C is a cross-sectional view illustrating a cross section cut along the dashed-dotted line B1-B2 in FIG. 2A. One end portion of the stacked portion 61 is in contact with the region including the first spacer 55 (see FIG. 2B), and the other end portion thereof includes a region in contact with the flexible film 58 (see FIG. 2C).

Although the flexible film 58 is not necessarily provided in the above described position of the secondary battery 10, the flexible film 58 is preferably provided because the slidability between the stacked portion 61 and the exterior body 50 can be improved when the flexible film 58 is provided in that position.

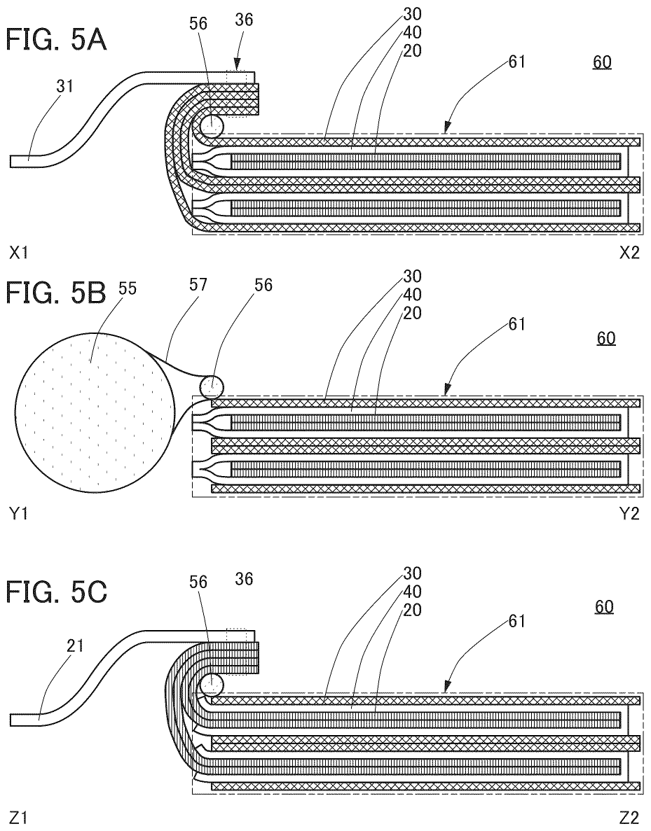

FIG. 5A to FIG. 5C are cross-sectional views illustrating the inside of the secondary battery 10, FIG. 5A is a cross-sectional view illustrating a cross section of the stack 60 cut along a dashed-dotted line X1-X2 in FIG. 2A, FIG. 5B is a cross-sectional view illustrating a cross section of the stack 60 cut along a dashed-dotted line Y1-Y2 in FIG. 2A, and FIG. 5C is a cross-sectional view illustrating a cross section of the stack 60 cut along a dashed-dotted line Z1-Z2 in FIG. 2A.

As illustrated in FIG. 5A to FIG. 5C, the stack 60 includes the stacked portion 61 in which the positive electrode 20, the negative electrode 30, and the separator 40 are stacked. As illustrated in FIG. 3A and FIG. 4A, the negative electrode 30 includes the negative electrode current collector exposed portion 34 and the negative electrode active material coated portion 35, and the positive electrode 20 includes the positive electrode current collector exposed portion 24 and the positive electrode active material coated portion 25. In the stacked portion 61, the positive electrode active material coated portion 25, the negative electrode active material coated portion 35, and the separator have an overlap region.

As illustrated in FIG. 5A, the negative electrode 30 is connected to the negative electrode lead 31 at the connection portion 36. The connection portion 36 is provided in the negative electrode current collector exposed portion 34 illustrated in FIG. 3A. The negative electrode current collector exposed portion 34 includes a curved portion between the connection portion 36 and the stacked portion 61, and the connection portion 36 overlaps with the stacked portion 61 in a cross-sectional view. The second spacer 56 includes a region sandwiched between the negative electrode current collector exposed portion 34 and the stacked portion 61, and is preferably in contact with part of the curved portion of the negative electrode current collector exposed portion 34 as illustrated in FIG. 5A.

As illustrated in FIG. 5B, the second spacer 56 includes a region not sandwiched between the negative electrode current collector exposed portion 34 and the stacked portion 61 and a region not sandwiched between the positive electrode current collector exposed portion 24 and the stacked portion 61, and includes the region connected to the first spacer 55 through the connection portion 57.

As illustrated in FIG. 5C, the positive electrode 20 is connected to the positive electrode lead 21 at the connection portion 26. The connection portion 26 is provided in the positive electrode current collector exposed portion 24 illustrated in FIG. 4A. The positive electrode current collector exposed portion 24 includes a curved portion between the connection portion 26 and the stacked portion 61, and the connection portion 26 overlaps with the stacked portion 61 in a cross-sectional view. The second spacer 56 includes a region sandwiched between the positive electrode current collector exposed portion 24 and the stacked portion 61, and is preferably in contact with part of the curved portion of the positive electrode current collector exposed portion 24 as illustrated in FIG. 5C.

As described above, the second spacer 56 includes the region sandwiched between the negative electrode current collector exposed portion 34 and the stacked portion 61, the region sandwiched between the positive electrode current collector exposed portion 24 and the stacked portion 61, and the region connected to the first spacer 55 through the connection portion 57. The stacked portion 61 is connected to the first spacer 55 through the second spacer 56 and the connection portion 57. Since the first spacer 55 includes the region in contact with the exterior body 50 as illustrated in FIG. 2B and the like, the stacked portion 61 is connected to the exterior body 50 through the second spacer 56, the connection portion 57, and the first spacer 55.

With such an internal structure, in the secondary battery 10, a portion where the exterior body 50 and the stacked portion 61 are fixed can be provided in addition to the positive electrode lead 21 and the negative electrode lead 31, so that deterioration of the positive electrode lead 21, the negative electrode lead 31, the connection portion 26, the connection portion 36, and the periphery thereof at the time when the secondary battery 10 is curved can be inhibited.

Note that the height of the first spacer 55 is preferably greater than or equal to the sum of the height of the stacked portion 61, the height of the second spacer 56, the height of the connection portion 26 or the connection portion 36, and the height of the positive electrode lead 21 or the negative electrode lead 31. The height of the first spacer 55 is preferably less than or equal to 2.0 times, further preferably less than or equal to 1.5 times, still further preferably less than or equal to 1.3 times, still further preferably less than or equal to 1.2 times, yet further preferably less than or equal to 1.1 times the sum of the height of the stacked portion 61, the height of the second spacer 56, the height of the connection portion 26 or the connection portion 36, and the height of the positive electrode lead 21 or the negative electrode lead 31.

As the first spacer 55 and the second spacer 56, for example, an insulating material such as a resin (e.g., a polyolefin resin, a polyimide resin, a polyamide resin, an acrylic resin, a siloxane resin, an epoxy resin, or a phenol resin), glass, an amorphous compound, or ceramics can be used. In particular, a polyolefin resin with insulating property and moderate elasticity is preferably used. Note that as the elasticity of the first spacer 55 and the second spacer 56, the elasticity of the first spacer 55 is preferably higher than that of the second spacer 56.

That is, the second spacer 56 is preferably more easily changed in shape than the first spacer 55. This is because the second spacer 56 is provided at a position in contact with a positive electrode tab and a negative electrode tab and thus in the case where the elasticity of the second spacer 56 is high, deterioration such as a crack in the positive electrode tab and the negative electrode tab is more likely to occur.

Note that in this specification, the elasticity refers to a property of an object whose shape or volume is changed by external force to return to its original condition after the force is removed. In addition, high elasticity means that large external force is required for change in shape of an object.

Although the example in which the first spacer and the second spacer each have a cylindrical shape is described, the shape is not limited thereto. The first spacer and the second spacer may have a hollow pipe-like shape, a rectangular solid shape, a spherical shape, a polyhedron shape with seven or more faces, or a shape in which those shapes are combined.

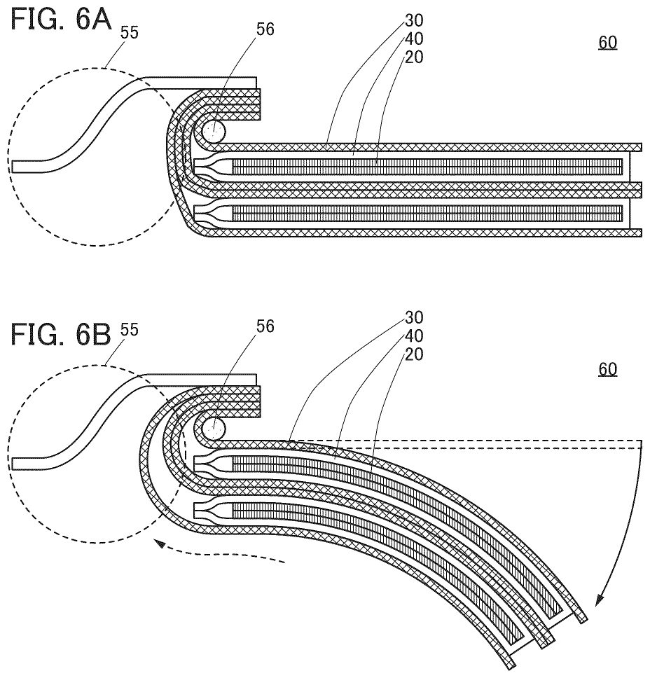

The internal structure at the time when the secondary battery 10 of one embodiment of the present invention is curved is described with reference to FIG. 6A and FIG. 6B. FIG. 6A is a cross-sectional view illustrating a cross section of the stack 60 cut along the dashed-dotted line X1-X2 in FIG. 5A, in which the position of the first spacer 55 is additionally indicated by the dashed line. FIG. 6B is a diagram illustrating a state where the structure illustrated in FIG. 6A changes when the secondary battery 10 is curved.

Since FIG. 6A is similar to FIG. 5A, the descriptions thereof are omitted. FIG. 6B is a diagram illustrating the case where the secondary battery 10 is curved in a direction indicated by a solid arrow. In that case, as illustrated, the negative electrode 30 can move in a direction indicated by a dashed arrow (in other words, the negative electrode 30 can be changed in shape). Such an operation is possible because the first spacer 55 includes the region in contact with the exterior body 50 and a space for moving the negative electrode 30 as in FIG. 5A is maintained inside the exterior body 50. In some cases, the second spacer 56 functions as a fulcrum of the change in shape of the negative electrode 30, and thus the negative electrode 30 illustrated in FIG. 5A can be changed in shape stably.

Note that in the case where the secondary battery 10 is curved, the positive electrode 20 along the dashed-dotted line Z1-Z2 illustrated in FIG. 5C can also be changed in shape as in the description of the change in shape of the negative electrode 30 in FIG. 6A and FIG. 6B.

### [Fabrication Method of Secondary Battery]

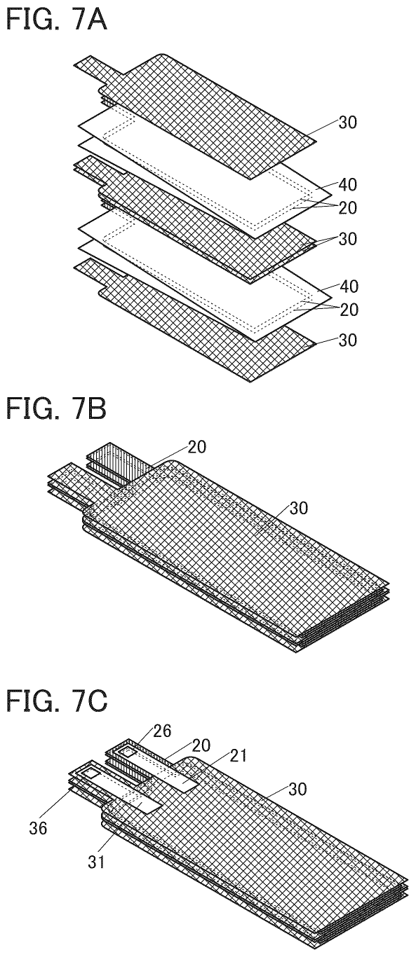

A fabrication method of a secondary battery is described with reference to FIG. 7A to FIG. 10.

First, a plurality of positive electrodes 20, a plurality of negative electrodes 30, and a plurality of separators 40 are prepared and stacked. FIG. 7A is a schematic perspective view showing the stacked-layer structure.

FIG. 7A illustrates an example in which four positive electrodes 20, four negative electrodes 30, and two separators 40 are used. The positive electrodes 20 and the negative electrodes 30 are the single-side-coated electrodes illustrated in FIG. 3B, FIG. 3C, FIG. 4B, and FIG. 4C, and the positive electrodes 20 overlap with each other so as to have the positive electrode current collectors 22 in contact with each other and are positioned so as to be sandwiched by the folded separator 40. Similarly, in the case where two negative electrodes 30 are in contact with each other, the negative electrodes 30 overlap with each other so as to have the negative electrode current collectors 32 in contact with each other. FIG. 7B illustrates a state where the positive electrode 20, the negative electrode 30, and the separator 40 are stacked. For clarity, the separator 40 is not shown in FIG. 7B and FIG. 7C.

Here, the separator 40 is preferably shaped into a bag-like form by bonding the surrounding portion after the separator 40 is folded back. The use of such the separator 40 can inhibit an electrical short circuit between the positive electrode and the negative electrode even when the positions of the pair of positive electrode current collectors 22 are shifted.

Instead of making two negative electrodes 30 overlap with each other so that the negative electrode current collectors 32 are in contact with each other, a double-side-coated electrode illustrated in FIG. 3D may be used, and instead of making two positive electrodes 20 overlap with each other so that the positive electrode current collectors 22 are in contact with each other, a double-side-coated electrode illustrated in FIG. 4D may be used. In the case where single-side-coated electrodes are used as in the example illustrated in FIG. 7A, current collectors of the same polarity preferably slide each other, which relieves stress applied to the current collectors themselves when the battery is bent.

Next, as illustrated in FIG. 7C, the negative electrodes 30 and the negative electrode lead 31 are connected and the positive electrodes 20 and the positive electrode lead 21 are connected. The negative electrode lead 31 is connected to the negative electrodes 30 at the connection portion 36 and the positive electrode lead 21 is connected to the positive electrodes 20 at the connection portion 26. The connection can be performed by ultrasonic welding, for example.

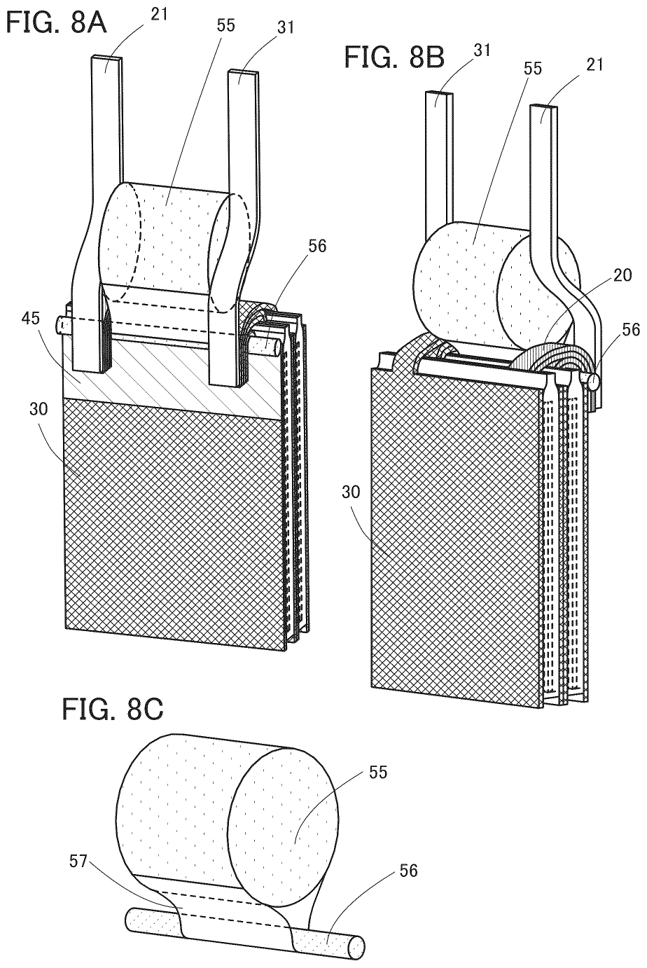

Next, as illustrated in FIG. 8A, the positive electrodes 20 and the negative electrodes 30 are curved such that the connection portion 26 and the connection portion 36 overlap with one surface of the stacked portion 61. At this time, the second spacer 56 is provided to be sandwiched between the connection portion 26 or the connection portion 36 and the stacked portion 61. As illustrated in FIG. 8A, an insulating film 45 is preferably provided in a position where the negative electrode 30 is in contact with the second spacer 56 and in a position where the connection portion 26 and the connection portion 36 overlap with the negative electrode current collector. Providing the insulating film 45 can prevent an unexpected short circuit between the positive electrode 20 and the negative electrode 30. The insulating film 45 may be fixed using an adhesive, or an insulating film including an adhesive layer may be used.

As the insulating film 45, for example, a film-like resin can be used. As a resin, a polyimide resin, a polyamide resin, an acrylic resin, a siloxane resin, an epoxy resin, a phenol resin, or the like can be used, for example. Furthermore, an adhesive layer containing a silicone resin or the like may be provided. The insulating film 45 preferably includes an adhesive layer, which allows the manufacturing step illustrated in FIG. 8A to be easily performed and improves the workability in a later step.

Note that FIG. 8B is a schematic perspective view of the stack 60 illustrated in FIG. 8A seen from another angle.

As illustrated in FIG. 8C, the first spacer 55 is connected to the second spacer 56 through the connection portion 57. Although the first spacer 55 and the second spacer 56 may be connected after the step illustrated in FIG. 8A, they are preferably connected before the step in terms of workability.

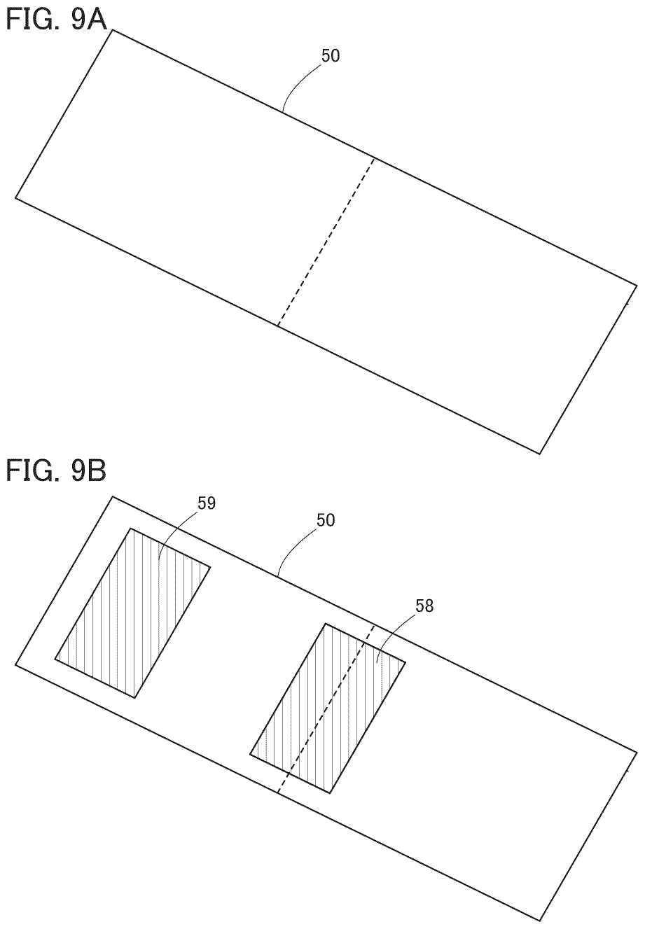

Next, the exterior body 50 is prepared as illustrated in FIG. 9A. The dashed line in the drawing represents a folding line in the case where a three-side sealing structure is employed. The film that can be used for the exterior body 50 will be described in detail later.

Next, as illustrated in FIG. 9B, the flexible film 58 and a flexible film 59 are attached to the exterior body 50. The flexible film 58 is preferably attached so as to include the above-described folding line and be in the position illustrated in FIG. 2C. An adhesive may be used for the attachment, or a flexible film including an adhesive layer may be used. The flexible film 59 is preferably attached so as to overlap with the connection portion 26 and the connection portion 36. Note that a structure in which the flexible film 58 and the flexible film 59 are not attached, or a structure in which the flexible film 58 is attached and the flexible film 59 is not attached may be employed.

As the flexible film 58 and the flexible film 59, for example, a film-like resin can be used. As a resin, a polyimide resin, a polyamide resin, an acrylic resin, a siloxane resin, an epoxy resin, a phenol resin, or the like can be used, for example. Furthermore, an adhesive layer containing a silicone resin or the like may be provided. The flexible film 58 and the flexible film 59 preferably include an adhesive layer, which allows the manufacturing step illustrated in FIG. 9B to be easily performed and improves the workability in a later step.

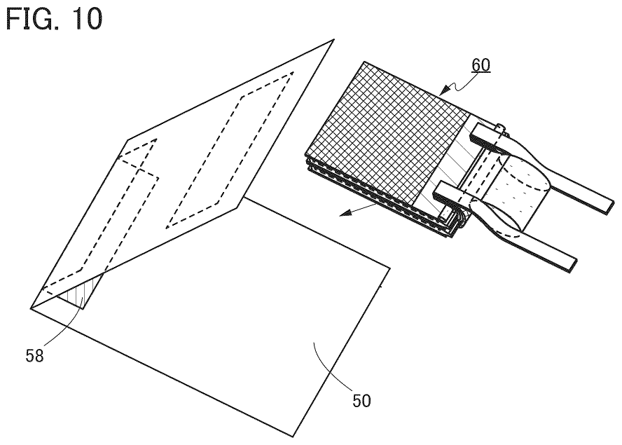

Next, as illustrated in FIG. 10, the exterior body 50 is folded in half, the stack 60 is placed between the folded exterior body 50, and the exterior body is sealed with an electrolyte-injection portion left as an aperture.

Next, an electrolyte is injected from one side left as the aperture in an argon gas atmosphere, and the periphery of the exterior body 50 is sealed in a reduced-pressure environment. The reduced pressure is preferably lower than or equal to 50000 Pa, further preferably lower than or equal to 40000 Pa, lower than or equal to 30000 Pa, lower than or equal to 20000 Pa, lower than or equal to 10000 Pa, lower than or equal to 5000 Pa, or lower than or equal to 1000 Pa.

After the introduction of the electrolyte, impregnation treatment for facilitating impregnation of pores of the electrodes and the separators with the electrolyte may be performed. As the impregnation treatment, decompression treatment (also referred to as evacuation to a vacuum) is preferably performed, and the decompression treatment may be performed a plurality of times. In the case where an electrolyte containing an ionic liquid is used as the electrolyte, the environmental pressure (a pressure value read by a differential pressure gauge) in the decompression treatment can be lower than or equal to −60 kPa.

The environmental pressure in the decompression treatment is preferably lower than or equal to −80 kPa or lower than or equal to −100 kPa. The sealing of the exterior bodies can be performed at the same environmental pressure as the decompression treatment. Alternatively, the sealing may be performed at the environmental pressure different from that in the decompression treatment; for example, the decompression treatment can be performed at an environmental pressure of −100 kPa and the sealing of the exterior bodies can be performed in a pressure environment of −80 kPa.

In this manner, the secondary battery 10 of one embodiment of the present invention illustrated in FIG. 1A and the like can be fabricated.

### [Negative Electrode]

A negative electrode includes a negative electrode active material layer and a negative electrode current collector. The negative electrode active material layer includes a negative electrode active material and may further contain a conductive material and a binder.

Metal foil can be used as the current collector, for example. The negative electrode can be formed by applying slurry onto the metal foil and drying the slurry. Note that pressing may be performed after drying. The negative electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

As the negative electrode active material, for example, a carbon material or an alloy-based material can be used.

As the carbon material, for example, graphite (natural graphite and artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used here. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind of negative electrode active material among the negative electrode active materials shown above can be used; alternatively, a plurality of kinds can be used in combination. For example, a combination of a carbon material and silicon or a combination of a carbon material and silicon monoxide can be used.

As another mode of the negative electrode, a negative electrode that does not contain a negative electrode active material after completion of the fabrication of the battery may be used. The negative electrode that does not contain a negative electrode active material can be, for example, a negative electrode in which only a negative electrode current collector is included after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. As another film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case where the negative electrode that does not contain a negative electrode active material is used, a negative electrode current collector having projections and depressions can be used. In the case where the negative electrode current collector having projections and depressions is used, a depression of the negative electrode current collector becomes a cavity in which lithium contained in the negative electrode current collector is easily deposited, so that the lithium can be inhibited from having a dendrite-like shape when being deposited.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other.

An active material layer such as the positive electrode active material layer or the negative electrode active material layer preferably contains a conductive material.

As the conductive material, for example, one kind or two or more kinds of carbon black such as acetylene black or furnace black, graphite such as artificial graphite or natural graphite, carbon fiber such as carbon nanofiber or carbon nanotube, and a graphene compound can be used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved. The graphene compound may be rounded like a carbon nanofiber.

The active material layer may contain, as a conductive material, metal powder or metal fiber of copper, nickel, aluminum, silver, gold, or the like, a conductive ceramic material, or the like.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, a graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density per volume and stability, and is effective as an in-vehicle battery.

### <Current Collector>

As the current collector, a highly conductive material which does not alloy with a carrier ion of lithium or the like, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (e.g., polypropylene or polyethylene), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. For example, one kind or two or more kinds of carbon black such as acetylene black or furnace black, graphite such as artificial graphite or natural graphite, carbon fiber such as carbon nanofiber or carbon nanotube, graphene, and a graphene compound can be used as the conductive carbon material. Note that in the case where the resin current collector is used as a positive electrode current collector, an antioxidant such as a hindered phenol-based material is further preferably used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

Note that the average particle diameter of the conductive material contained in the resin current collector can be greater than or equal to 10 nm and less than or equal to 10 μm, and is preferably greater than or equal to 30 nm and less than or equal to 5 μm.

The current collector preferably has a thickness greater than or equal to 5 μm and less than or equal to 30 μm.

Note that a material that does not alloy with carrier ions of lithium or the like is preferably used for the negative electrode current collector.

### [Positive Electrode]

A positive electrode includes a positive electrode active material layer and a positive electrode current collector. The positive electrode active material layer includes a positive electrode active material and may further contain at least one of a conductive material and a binder. Note that the positive electrode current collector, the conductive material, and the binder described in [Negative electrode] can be used.

Metal foil can be used as the current collector, for example. The positive electrode can be formed by applying slurry over the metal foil and drying it. Note that pressing may be performed after drying. The positive electrode is obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, one or more of a composite oxide having a layered rock-salt structure, a composite oxide having an olivine structure, and a composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, composite oxide having a spinel structure, e.g., LiMn₂O₄, can be used.

### [Electrolyte]

Examples of the electrolyte are described below. As one mode of the electrolyte, a liquid electrolyte (also referred to as an electrolyte solution) containing a solvent and an electrolyte dissolved in the solvent can be used. The electrolyte is not limited to a liquid electrolyte (electrolyte solution) that is liquid at room temperature, and a solid electrolyte can be used as well. Alternatively, an electrolyte including both a liquid electrolyte that is liquid at room temperature and a solid electrolyte that is a solid at room temperature (such an electrolyte is referred to as a semi-solid electrolyte) can also be used. Note that when the solid electrolyte or the semi-solid electrolyte is used for a bendable battery, employing a structure where part of a stack in the battery includes the electrolyte can maintain the flexibility of the battery.

In the case where a liquid electrolyte is used for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio, for example.

Alternatively, the use of one or more of ionic liquids (normal temperature molten salts) which have features of non-flammability and non-volatility as a solvent of an electrolyte can prevent a secondary battery from exploding or catching fire even when an internal region of a secondary battery shorts out or the temperature in the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100-x-y (where 5≤x≤35 and 0<y<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is placed between the positive electrode and the negative electrode. The separator can be formed using, for example, fiber containing cellulose, such as paper, nonwoven fabric, glass fiber, ceramics, or synthetic fiber containing nylon (polyamide), polyimide vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the battery can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the battery can be increased because the safety of the battery can be maintained even when the total thickness of the separator is small.

### [Exterior Body]

For an exterior body included in the battery, a resin material or a metal material such as aluminum, stainless steel, or titanium can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

A graphene sheet may be substituted for the above metal layer of the laminated film. As the graphene sheet, a multilayer graphene sheet with a thickness greater than or equal to 100 nm and less than or equal to 30 μm, preferably greater than or equal to 200 nm and less than or equal to 20 μm can be used. The graphene sheet is flexible and has a gas barrier property with the interlayer distance of graphene of 0.34 nm and thus is suitable as a film used for the exterior body of the secondary battery.

[Processing Method of Film with Projections and Depressions]

Next, a processing method of a film that can be used for the exterior body 50 will be described. The laminated film described above can be used as the film.

As the laminated film, a stacked-layer film can be used, for example. As the stacked-layer film, for example, a metal film including a heat-seal layer on one surface or both surfaces can be used. As an adhesive layer, a heat-sealing resin film containing polypropylene, polyethylene, or the like can be used. This embodiment employs an aluminum laminated film in which a nylon resin is provided on the top surface of aluminum foil and a stack of an acid-resistant polypropylene film and a polypropylene film is provided on the back surface of the aluminum foil.

Then, the film is embossed. As a result, the film having projections and depressions can be obtained. The film includes a plurality of projections and depressions, thereby having a wave pattern that can be visually recognized.

Embossing, which is a type of pressing, will be described below.

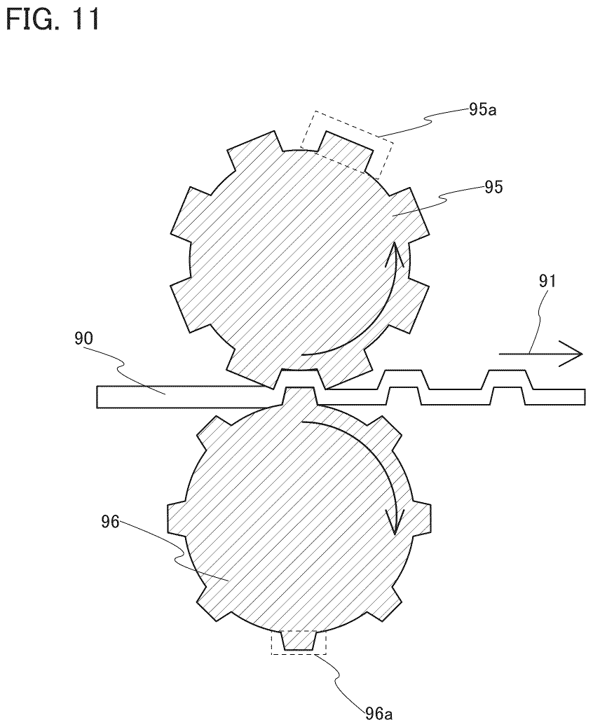

FIG. 11 is a cross-sectional view illustrating an example of embossing. Note that embossing, which is a type of pressing, refers to processing in which an embossing roll whose surface has depressions and projections is brought in contact with a film with pressure to form, on the film, depressions and projections corresponding to the depressions and projections of the embossing roll. Note that the embossing roll is a roll whose surface is engraved with a pattern.

FIG. 11 illustrates an example of embossing both surfaces of a film. FIG. 11 illustrates a method for forming a film having projected portions whose tops are on one surface.

FIG. 11 illustrates a state where a film 90 is sandwiched between an embossing roll 95 in contact with one surface of the film and an embossing roll 96 in contact with the other surface and the film 90 is being transferred in a film traveling direction 91. The surface of the film is patterned by pressure or heat. Note that the surface of the film may be patterned by both pressure and heat.

As the embossing rolls, metal rolls, ceramic rolls, plastic rolls, rubber rolls, organic resin rolls, lumber rolls, or the like can be used as appropriate.

In FIG. 11, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between the adjacent projections 95a, a depression is positioned into which a projection formed on the film by the projection 96a of the male embossing roll 96 fits.

Successive embossing by which the film 90 partly stands out and debossing by which the film 90 is partly indented can form a projection and a flat portion successively. In this manner, a pattern can be formed on the film 90.

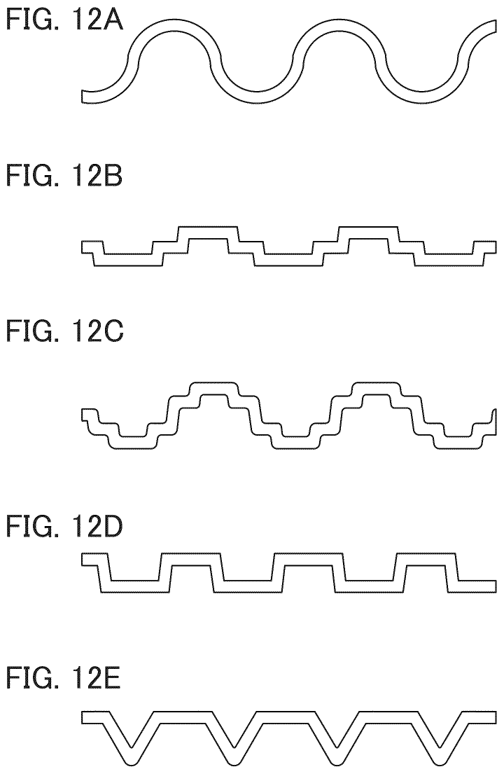

Next, a film having a plurality of projections with a shape different from that in FIG. 11 will be described with reference to FIG. 12A to FIG. 12E. The shape of projections of the embossing roll 95 and the embossing roll 96 in FIG. 11 are changed to a shape different from that in FIG. 11, whereby embossing with various cross-sectional shapes illustrated in FIG. 12A to FIG. 12E can be performed.

FIG. 12A is a schematic cross-sectional view of an embossment having a wave shape, and FIG. 12B to FIG. 12E show variation examples of FIG. 12A. FIG. 12B and FIG. 12C are diagrams illustrating examples of forming a stepwise wave shape, FIG. 12D is a diagram illustrating an example of forming a rectangular wave shape, and FIG. 12E is a diagram illustrating an example of forming a wave shape with acute troughs and trapezoidal crests.

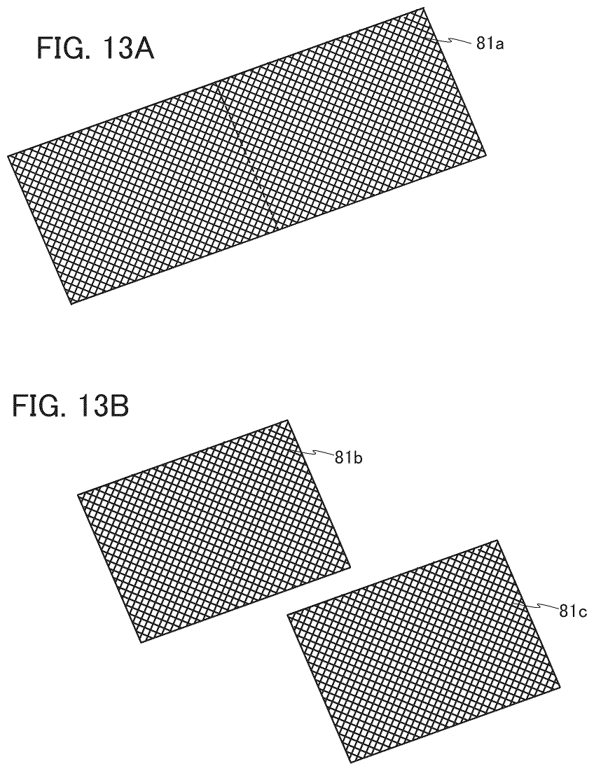

FIG. 13A and FIG. 13B are bird's eye views illustrating the completed shapes obtained by performing the embossing illustrated in FIG. 11 to FIG. 12E twice with different orientations of the film 90. Specifically, embossing is performed on the film 90 in a first direction, and then embossing is performed on the film 90 in a second direction that is rotated 90° with respect to the first direction, whereby a film having an embossed shape (which can be referred to as an alternating wave shape) illustrated in FIG. 13A and FIG. 13B can be obtained. Note that when a secondary battery is fabricated using one film 81a, the film 81a having an alternating wave shape has an external shape illustrated in FIG. 13A and can be used by being folded in two along a dashed line portion. When a secondary battery is fabricated using two films (a film 81b and a film 81c), the plurality of films (the film 81b and the film 81c) each having an alternating wave shape have an external shape illustrated in FIG. 13B, and the film 81b and the film 81c can overlap with each other to be used.

The embossed shape illustrated in FIG. 13A and FIG. 13B may be formed by a manufacturing method other than the above-described manufacturing method. For example, when the embossing roll has a criss-cross pattern, an embossed shape similar to that illustrated in FIG. 13A and FIG. 13B can be obtained by one-time embossing.

When processing is performed using the embossing rolls in the aforementioned manner, an apparatus can be small. Furthermore, a film before being cut can be processed, achieving excellent mass productivity. Note that a film processing method is not limited to processing using embossing rolls; a film may be processed by pressing a pair of embossing plates having a surface with projections and depressions against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

This embodiment can be implemented in appropriate combination with the other embodiments.

### Embodiment 2

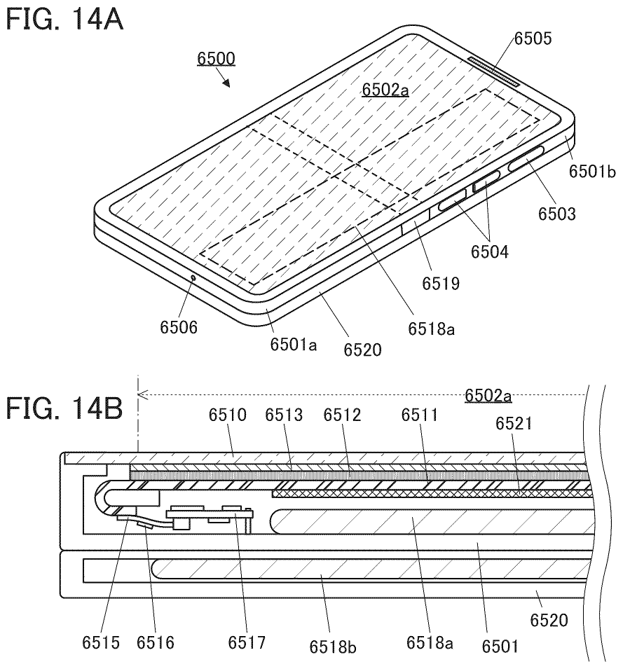

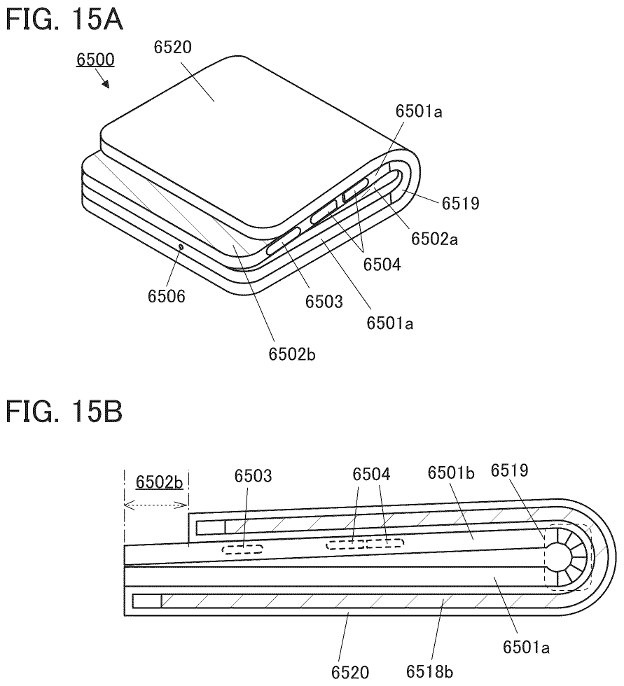

In this embodiment, an electronic device including the secondary battery 10 of one embodiment of the present invention will be described with reference to FIG. 14 and FIG. 15.

An electronic device 6500 illustrated in FIG. 14A is a portable information terminal that can be used as a smartphone.

The electronic device 6500 includes at least a first housing 6501a, a second housing 6501b, a hinge portion 6519, a first display portion 6502a, a power button 6503, buttons 6504, a speaker 6505, and a microphone 6506. The first display portion 6502a has a touch panel function. The first housing 6501a and the second housing 6501b are connected to each other through the hinge portion 6519.

The electronic device 6500 can be folded at the hinge portion 6519.

FIG. 14B is a schematic cross-sectional view including an end portion of the housing 6501 (6501a and 6501b) on the microphone 6506 side.

A protection member 6510 having a light-transmitting property is provided on the display surface side of the housing 6501 (6501a and 6501b), and a display panel 6511, an optical member 6512, a touch sensor panel 6513, a printed circuit board 6517, and a first battery 6518a are provided in a space surrounded by the housing 6501 (6501a and 6501b) and the protection member 6510.

The display panel 6511, the optical member 6512, and the touch sensor panel 6513 are fixed to the protection member 6510 with an adhesive layer (not illustrated).

Part of the display panel 6511 is folded back in a region outside the first display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix. As the light-emitting elements, EL elements (also referred to as EL devices) such as OLEDs or QLEDs are preferably used. Examples of a light-emitting substance contained in the EL element include a substance that emits fluorescent light (a fluorescent material), a substance that emits phosphorescent light (a phosphorescent material), an inorganic compound (a quantum dot material or the like), and a substance exhibiting thermally activated delayed fluorescence (a thermally activated delayed fluorescent (TADF) material). An LED such as a micro LED can also be used as the light-emitting element.

The use of the flexible display allows the display panel 6511 to be provided at a position overlapping with the first housing 6501a, the second housing 6501b, and the hinge portion 6519, and to be folded at the hinge portion 6519.

The use of the flexible display allows an internal space of the housing 6501 (6501a and 6501b) to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated. The flexible battery of one embodiment of the present invention can be used as the first battery 6518a and the second battery 6518b.

The use of the flexible battery allows the battery to be provided at a position overlapping with the first housing 6501a, the second housing 6501b, and the hinge portion 6519, and to be folded at the hinge portion 6519.

Part of the display panel 6511 is folded back such that a connection portion with the FPC 6515 is provided on the rear side of the pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

FIG. 15A is a perspective view illustrating a folded state along the dotted line portion in FIG. 14A. The electronic device 6500 can be folded in two; the first display portion 6502a and the second battery 6518b can be folded repeatedly.

FIG. 15A has a structure in which a second display portion 6502b is provided in a portion exposed when the cover portion 6520 slides by folding. Even when the electronic device 6500 is folded in half, a user can check simple time display or e-mail reception notification display by seeing the second display portion 6502b.

FIG. 15B schematically illustrates a cross-sectional state of the cover portion in a state where the electronic device 6500 is folded. In FIG. 15B, the inside of the housing 6501 (6501a and 6501b) is not illustrated for simplicity.

In FIG. 15B, the hinge portion 6519 can be referred to as a connection portion and can have various modes as well as a structure example in which a plurality of columnar bodies are connected. In particular, the hinge portion 6519 preferably has a mechanism capable of curving the first display portion 6502a and the second battery 6518b without expansion and contraction.

Although the second battery 6518b is illustrated inside the cover portion 6520, a plurality of second batteries may be included. In addition, a charging control circuit or a wireless charging circuit of the second battery 6518b may be provided inside the cover portion 6520.

In the example, the cover portion 6520 is partly fixed to the housing 6501 (6501a and 6501b) and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 (6501a and 6501b) and may be detachable. In the case where high capacity is not needed, the electronic device 6500 can be used while the cover portion 6520 is detached and the first battery 6518a is used. Charging of the detached second battery 6518b allows supplementary charging of the first battery 6518a when the second battery 6518b is reconnected to the first battery 6518a. Thus, the cover portion 6520 can also be used as a mobile battery.

FIG. 15A and FIG. 15B illustrate an example in which the first display portion 6502a is folded in two such that the display surface faces inside; however, there is no particular limitation and the hinge portion 6519 may have a structure allowing the display portion 6502a to be folded in two such that the display surface faces outside.

The flexible battery of one embodiment of the present invention has high reliability with respect to repetitive deformation, and thus can be suitably used for the device that can be folded (also referred to as a foldable device).

At least part of this embodiment can be implemented in combination with the other embodiments described in this specification as appropriate.

### Embodiment 3

In this embodiment, examples of electronic devices each including the secondary battery 10 of one embodiment of the present invention will be described. Examples of the electronic device including the battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

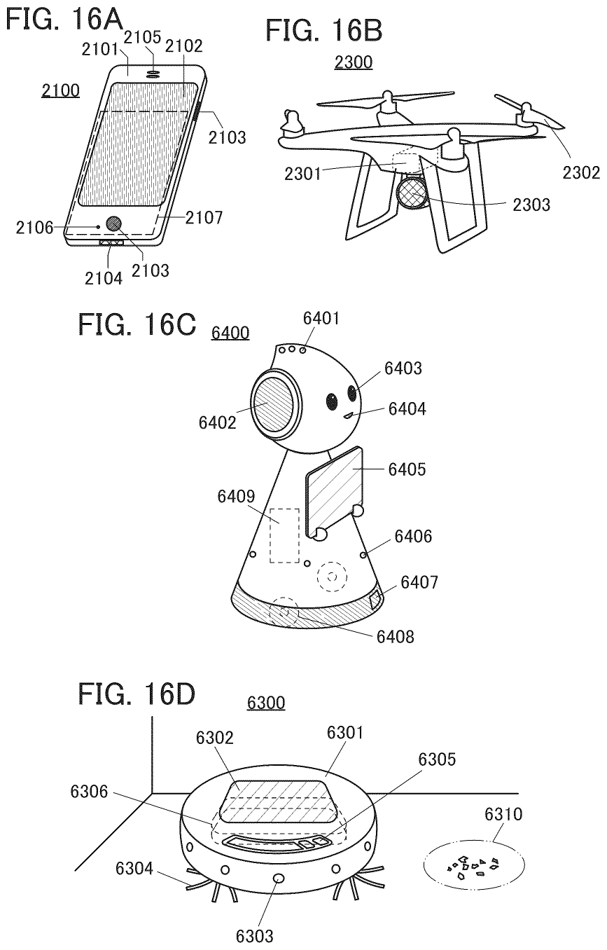

FIG. 16A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a battery 2107. The battery 2107 can be bent and thus can be mounted in a bendable region of the mobile phone 2100.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 16B illustrates an unmanned aircraft 2300 including a plurality of rotors 2302. The unmanned aircraft 2300 is sometimes also referred to as a drone. The unmanned aircraft 2300 includes a battery 2301 of one embodiment of the present invention, a camera 2303, and an antenna (not illustrated). The unmanned aircraft 2300 can be remotely controlled through the antenna. The battery 2301 can be bent and mounted in a bendable region of the unmanned aircraft 2300.

FIG. 16C illustrates an example of a robot. A robot 6400 illustrated in FIG. 16C includes a battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The battery 6409 can be bent and mounted in a bendable region of the robot 6400.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the battery 6409 of one embodiment of the present invention and a semiconductor device or an electronic component.

FIG. 16D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface. The battery 6306 can be bent and mounted in a bendable region of the cleaning robot 6300.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the battery 6306 of one embodiment of the present invention and a semiconductor device or an electronic component.

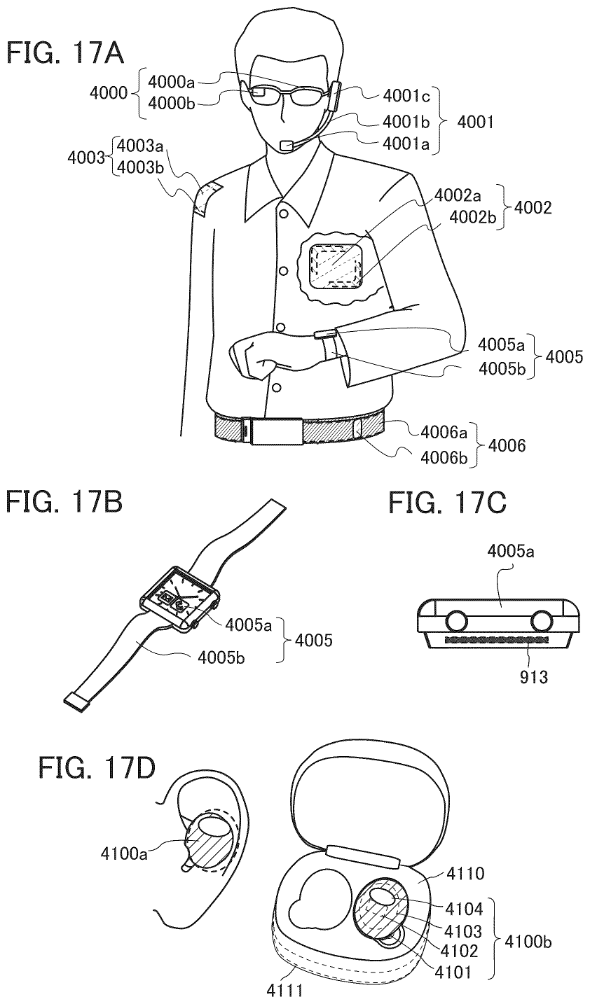

FIG. 17A illustrates examples of wearable devices. A flexible battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the flexible battery of one embodiment of the present invention can be provided in a glasses-type device 4000 illustrated in FIG. 17A. The glasses-type device 4000 includes a frame 4000a and a display portion 4000b. The flexible battery is provided in a temple portion of the frame 4000a having a curved shape, whereby the glasses-type device 4000 can be lightweight, can have a well-balanced weight, and can be used continuously for a long time. The flexible battery can be bent and mounted in a curved portion.

The battery of one embodiment of the present invention can be provided in a headset-type device 4001. The headset-type device 4001 includes at least a microphone portion 4001a, a flexible pipe 4001b, and an earphone portion 4001c. The battery can be provided in the flexible pipe 4001b or the earphone portion 4001c. The battery can be bent and mounted in a curved portion.

The flexible battery of one embodiment of the present invention can be provided in a device 4002 that can be attached directly to a body. A flexible battery 4002b can be provided in a thin housing 4002a of the device 4002. The flexible battery can be bent and mounted in a curved portion.

The flexible battery of one embodiment of the present invention can be provided in a device 4003 that can be attached to clothes. A flexible battery 4003b can be provided in a thin housing 4003a of the device 4003. The flexible battery can be bent and mounted in a curved portion.

The flexible battery of one embodiment of the present invention can be provided in a belt-type device 4006. The belt-type device 4006 includes a belt portion 4006a and a wireless power feeding and receiving portion 4006b, and the flexible battery can be provided in the inner region of the belt portion 4006a. The flexible battery can be bent and mounted in a curved portion.

The flexible battery of one embodiment of the present invention can be provided in a watch-type device 4005. The watch-type device 4005 includes a display portion 4005a and a belt portion 4005b, and the flexible battery can be provided in the display portion 4005a or the belt portion 4005b. The flexible battery can be bent and mounted in a curved portion.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 17B illustrates a perspective view of the watch-type device 4005 that is detached from an arm.

FIG. 17C illustrates a side view. FIG. 17C illustrates a state where a flexible battery 913 is incorporated in the inner region. The flexible battery 913 is provided to overlap with the display portion 4005a, can have high density and high capacity, and is small and lightweight. The flexible battery 913 can be bent and mounted in a curved portion.

FIG. 17D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a flexible battery 4103. A display portion 4104 may also be included. Moreover, a substrate where a circuit such as a wireless IC is provided, a terminal for charge, and the like are preferably included. Furthermore, a microphone may be included. The flexible battery 4103 can be bent and mounted in a curved portion.

A case 4110 includes a flexible battery 4111. Moreover, a substrate where a circuit such as a wireless IC or a charge control IC is provided, and a terminal for charge are preferably included. Furthermore, a display portion, a button, and the like may be included. The flexible battery 4111 can be bent and mounted in a curved portion.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The flexible battery 4103 included in the main body 4100a can be charged by the flexible battery 4111 included in the case 4110. The flexible battery 4111 and the flexible battery 4103 can be bent and mounted in a curved portion.

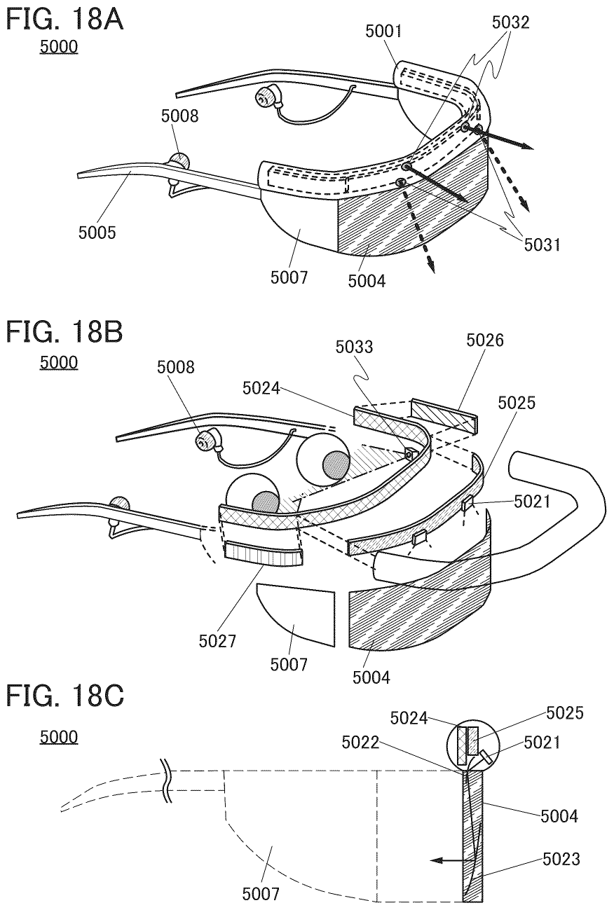

FIG. 18A to FIG. 18C illustrate another example of the glasses-type device. FIG. 18A is a perspective view of a glasses-type device 5000.

The glasses-type device 5000 has a function of what is called a portable information terminal and can execute a variety of programs and reproduce a variety of contents when connected to the Internet, for example. For example, the glasses-type device 5000 has a function of displaying augmented reality contents in an AR mode. The glasses-type device 5000 may have a function of displaying virtual reality contents in a VR mode. Note that the glasses-type device 5000 may also have a function of displaying substitutional reality (SR) contents or mixed reality (MR) contents, in addition to AR and VR contents.

The glasses-type device 5000 includes a housing 5001, an optical member 5004, a wearing tool 5005, a light-blocking portion 5007, earphones 5008, and the like. The housing 5001 preferably has a cylindrical shape. The glasses-type device 5000 is preferably wearable on the user's head. Furthermore, it is preferred that the glasses-type device 5000 be worn such that the housing 5001 be positioned above the circumference of the user's head passing through the eyebrows and ears. When the housing 5001 has a cylindrical shape that is curved along the user's head, the glasses-type device 5000 can fit more snugly. The housing 5001 is fixed to the optical member 5004. The optical member 5004 is fixed to the wearing tool 5005 with the light-blocking portion 5007 or the housing 5001 therebetween.

The glasses-type device 5000 includes a display device 5021, a reflective plate 5022, a flexible battery 5024, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charge circuit, a power supply circuit, and the like. The flexible battery 5024 can be bent and mounted in a curved portion.

FIG. 18B illustrates components included in the glasses-type device 5000 in FIG. 18A. FIG. 18B is a schematic view illustrating details of the components included in the glasses-type device 5000 illustrated in FIG. 18A.

In the glasses-type device 5000 illustrated in FIG. 18B, the flexible battery 5024, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently; as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of flexible batteries 5024 may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

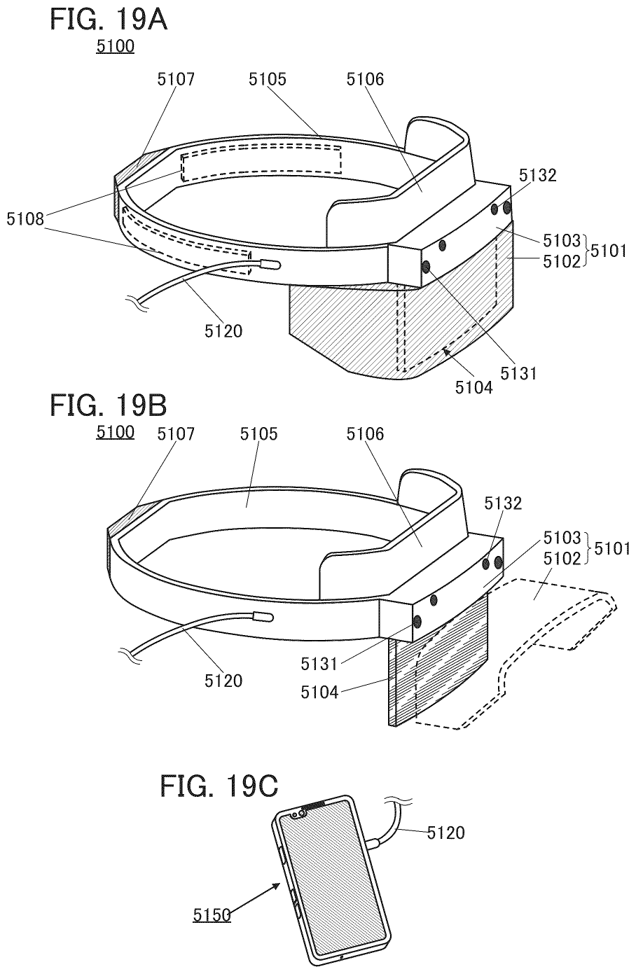

FIG. 19A to FIG. 19C illustrate an example of a head-mounted device. FIG. 19A and FIG. 19B illustrate a head-mounted device 5100 including a wearing tool 5105 with a band-like shape. The head-mounted device 5100 is connected to a terminal 5150 illustrated in FIG. 19C through a cable 5120.

FIG. 19A illustrates a first portion 5102 in a closed state, and FIG. 19B illustrates the first portion 5102 in an opened state. The first portion 5102 has a shape that covers not only the front but also the side of the face when closing. Accordingly, the user's view can be shielded from external light, so that realistic sensation and the sense of immersion can be increased. For example, it is also possible to increase the user's sense of fear in some contents to be displayed.

In the electronic device illustrated in FIG. 19A and FIG. 19B, the wearing tool 5105 has a band-like shape. Accordingly, the electronic device is less likely to slip as compared with the structure illustrated in FIG. 19A and the like and thus is preferable in enjoying content with relatively large quantity of motion, such as an attraction.

A flexible battery 5107 or the like may be incorporated on the rear head side of the wearing tool 5105. Striking a balance between the weight of the housing 5101 on the front head side and the weight of the flexible battery 5107 on the rear head side can adjust the barycenter of the head-mounted device 5100, whereby the device can be worn more comfortably.

A flexible battery 5108 having flexibility may be provided inside the wearing tool 5105 with a band-like shape. FIG. 19A illustrates an example in which two flexible batteries 5108 are provided inside the wearing tool 5105. The use of the flexible battery having flexibility is preferable, in which case the flexible battery can have a shape following a curved band shape.

The wearing tool 5105 includes a portion 5106 covering the user's forehead or front head. Owing to the portion 5106, the wearing tool 5105 is less likely to slip. An electrode can be provided in the portion 5106 or a portion of the housing 5101 in contact with the user's forehead to measure brain waves using the electrode.

This embodiment can be implemented in appropriate combination with the other embodiments.

### Embodiment 4

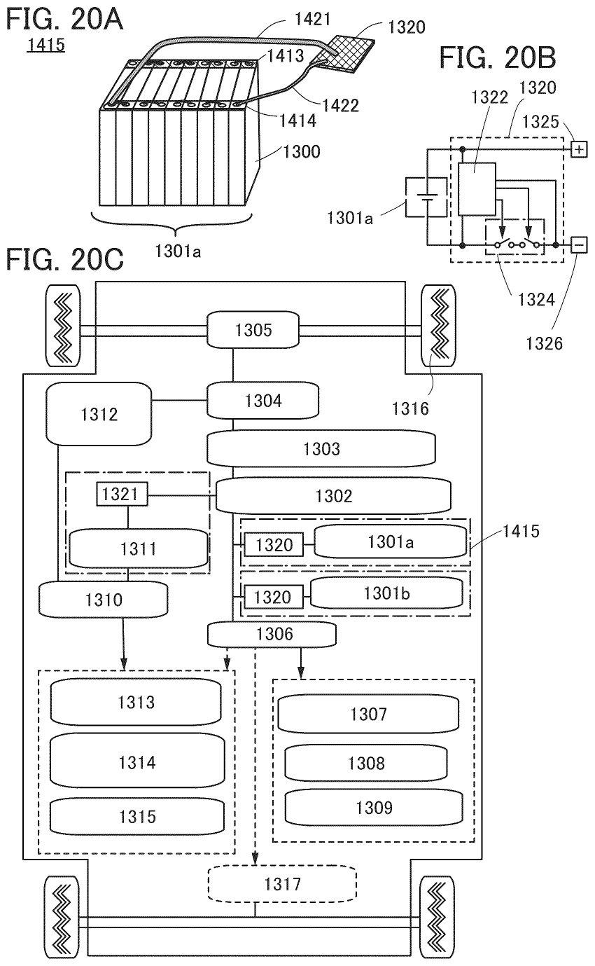

In this embodiment, application examples of the secondary battery of one embodiment of the present invention will be described with reference to FIG. 20 to FIG. 24.

### [Vehicle]

First, an example in which the secondary battery of one embodiment of the present invention is used in an electric vehicle (EV) will be described.

FIG. 20C illustrates a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 needs high output but does not necessarily have high capacity, and the capacity of the second battery 1311 is lower than that of the first batteries 1301a and 1301b.

For example, as one or both of the first batteries 1301a and 1301b, the secondary battery fabricated by the method for manufacturing the secondary battery of one embodiment of the present invention can be used.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DC-DC circuit 1306. Even in the case where there is a rear motor 1317 for rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DC-DC circuit 1310.

The first battery 1301a will be described with reference to FIG. 20A. The internal structure of the first battery 1301a may be the stacked structure illustrated in FIG. 1 and the like or the wound structure illustrated in FIG. 9 and the like.

FIG. 20A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharge, an output transistor of a charge circuit and an interruption switch can be turned off substantially at the same time.

FIG. 20B illustrates an example of a block diagram of the battery pack 1415 illustrated in FIG. 20A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is often used for the second battery 1311 due to cost advantage.

This embodiment describes an example in which a lithium-ion secondary battery is used as both the first battery 1301a and the second battery 1311. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging. The battery controller 1302 can set the charge voltage, charge current, and the like of the first batteries 1301a and 1301b. The battery controller 1302 can set charge conditions in accordance with charge performance of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By mounting the secondary battery of one embodiment of the present invention on vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines like an electric tractor, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. With the use of the method for manufacturing the secondary battery of one embodiment of the present invention, a large secondary battery can be fabricated. Thus, the secondary battery of one embodiment of the present invention can preferably be used in transport vehicles.

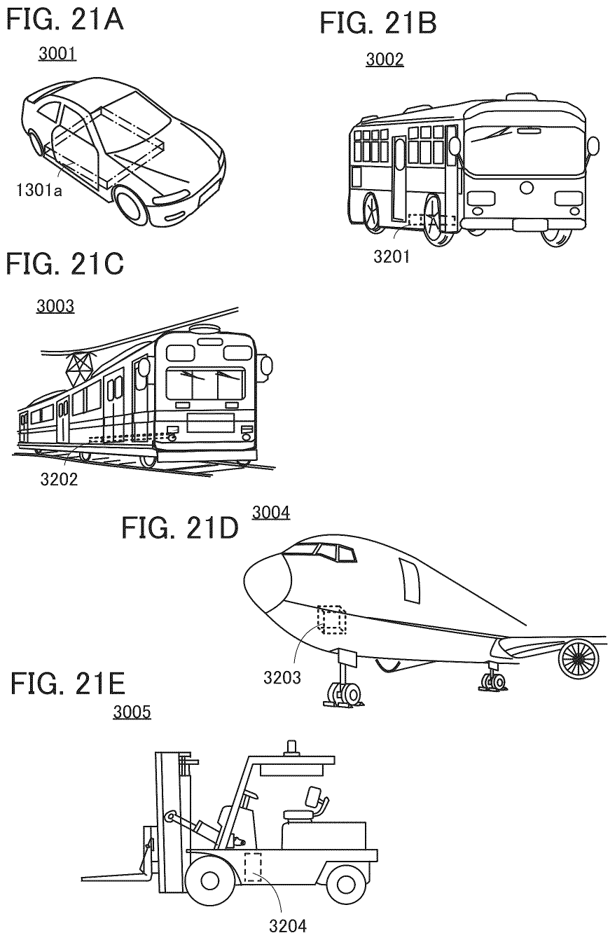

FIG. 21A to FIG. 21E illustrate transport vehicles each using the secondary battery of one embodiment of the present invention. A motor vehicle 3001 illustrated in FIG. 21A is an electric vehicle that runs using an electric motor as a driving power source. Alternatively, the motor vehicle 3001 is a hybrid vehicle that can appropriately select an electric motor or an engine as a driving power source. In the case where the secondary battery is mounted on the vehicle, the secondary battery is provided at one position or several positions. The motor vehicle 3001 illustrated in FIG. 21A includes the battery pack 1415 illustrated in FIG. 20A. The battery pack 1415 includes a secondary battery module. The battery pack 1415 preferably further includes a charge control device that is electrically connected to the secondary battery module. The secondary battery module includes one or more secondary batteries.

The motor vehicle 3001 can be charged when the secondary battery included in the motor vehicle 3001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. A charge apparatus may be a charge station provided in a commerce facility or a household power supply. For example, with the use of the plug-in system, the secondary battery mounted on the motor vehicle 3001 can be charged by being supplied with electric power from the outside. Charge can be performed by converting AC power into DC power through a converter such as an AC-DC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar panel may be provided in the exterior of the vehicle to charge the secondary battery when the vehicle stops or moves. To supply electric power in such a contactless manner, an electromagnetic induction method or a magnetic resonance method can be used. A solar panel is referred to as a solar cell module in some cases.

FIG. 21B illustrates a large transporter 3002 having a motor controlled by electricity, as an example of a transport vehicle. A secondary battery module of the transporter 3002 has a cell unit of four secondary batteries with 3.5 V or higher and 4.7 V or lower, and 48 cells are connected in series to have a maximum voltage of 170 V. A battery pack 3201 has the same function as the battery pack in FIG. 21A except, for example, the number of secondary batteries configuring the secondary battery module; thus, the description is omitted.

FIG. 21C illustrates a large transport vehicle 3003 having a motor controlled by electricity as an example. A secondary battery module of the transport vehicle 3003 has 100 or more secondary batteries with 3.5 V or higher and 4.7 V or lower which are connected in series, and the maximum voltage is 600 V, for example. Thus, the secondary batteries are required to have a small variation in the characteristics. With the use of the method for manufacturing the secondary battery of one embodiment of the present invention, a secondary battery with stable battery performance can be fabricated, and mass production at low cost is possible in view of the yield. A battery pack 3202 has the same function as the battery pack in FIG. 21A except, for example, the number of secondary batteries configuring the secondary battery module; thus, the description is omitted.

FIG. 21D illustrates an aircraft 3004 having a combustion engine as an example. The aircraft 3004 illustrated in FIG. 21D can be regarded as a kind of transport vehicles since it is provided with wheels for takeoff and landing, and has a battery pack 3203 that includes a charge control device and a secondary battery module configured by connecting a plurality of secondary batteries.

The secondary battery module of the aircraft 3004 has eight 4 V secondary batteries connected in series and has a maximum voltage of 32 V, for example. The battery pack 3203 has the same function as the battery pack in FIG. 21A except, for example, the number of secondary batteries configuring the secondary battery module; thus, the description is omitted.

FIG. 21E illustrates a transport vehicle 3005 that transports a load as an example. The transport vehicle 3005 includes a motor controlled by electricity and executes various operations with the use of electric power supplied from secondary batteries configuring a secondary battery module of a battery pack 3204. The transport vehicle 3005 is not limited to be operated by a human who rides thereon as a driver, and an unmanned operation is also possible by CAN communication or the like. Although FIG. 21E illustrates a forklift as an example, there is no particular limitation and a battery pack including the secondary battery of one embodiment of the present invention can be mounted on an industrial machine capable of being operated by CAN communication or the like, e.g., an automatic transport machine, a working robot, or small construction equipment.

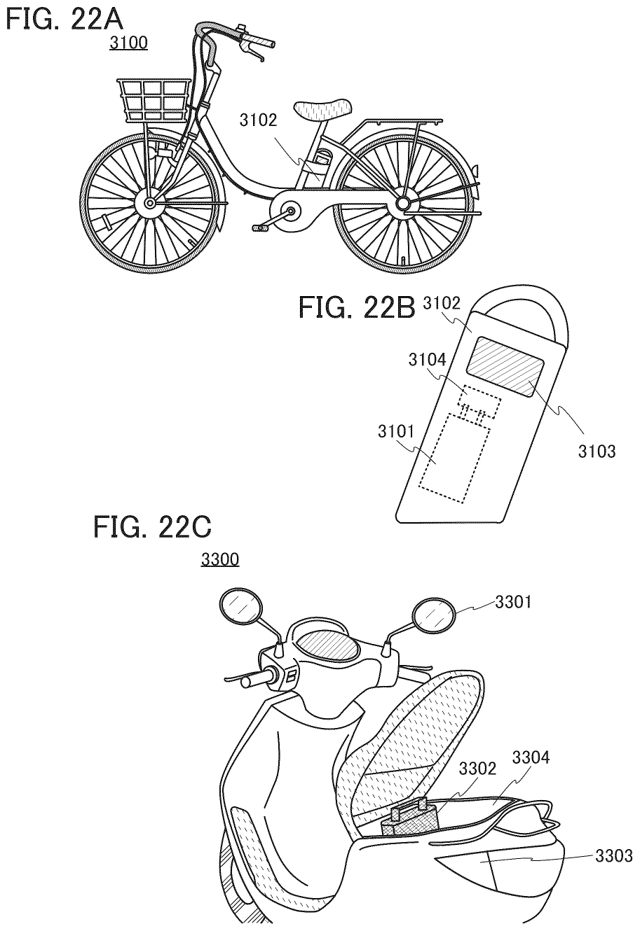

FIG. 22A illustrates an example of an electric bicycle using the secondary battery of one embodiment of the present invention. The secondary battery of one embodiment of the present invention can be used for an electric bicycle 3100 illustrated in FIG. 22A. A power storage device 3102 illustrated in FIG. 22B includes a plurality of secondary batteries and a protection circuit, for example.

The electric bicycle 3100 includes the power storage device 3102. The power storage device 3102 can supply electricity to a motor that assists a rider. The power storage device 3102 is portable, and FIG. 22B illustrates a state where the power storage device 3102 is detached from the bicycle. A plurality of secondary batteries 3101 of one embodiment of the present invention are incorporated in the power storage device 3102, and the remaining battery capacity and the like can be displayed on a display portion 3103. The power storage device 3102 includes a control circuit 3104 capable of charge control or anomaly detection for the secondary battery, which is exemplified in one embodiment of the present invention. The control circuit 3104 is electrically connected to a positive electrode and a negative electrode of the secondary battery 3101. The control circuit 3104 may be provided with a small solid-state secondary battery. When the small solid-state secondary battery is provided in the control circuit 3104, electric power can be supplied to retain data in a memory circuit included in the control circuit 3104 for a long time.

FIG. 22C illustrates an example of a motorcycle including the secondary battery of one embodiment of the present invention. A motor scooter 3300 illustrated in FIG. 22C includes a power storage device 3302, side mirrors 3301, and indicator lights 3303. The power storage device 3302 can supply electricity to the indicator lights 3303.

In the motor scooter 3300 illustrated in FIG. 22C, the power storage device 3302 can be stored in an under-seat storage unit 3304. Even in the case where the under-seat storage unit 3304 is small, the power storage device 3302 can be stored therein.

### [Building]

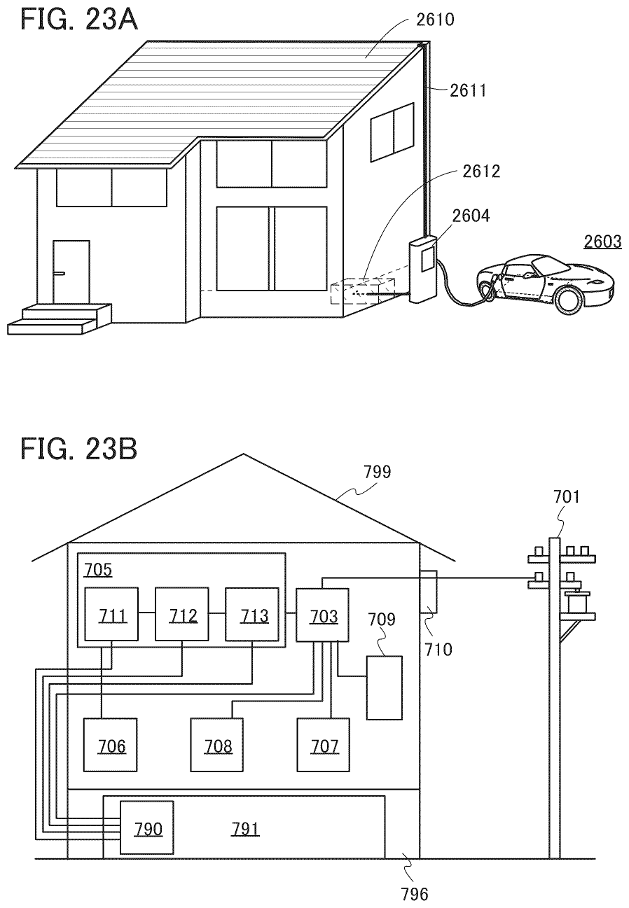

Next, examples in which the secondary battery of one embodiment of the present invention is mounted on a building will be described with reference to FIG. 23.

A house illustrated in FIG. 23A includes a power storage device 2612 including the secondary battery that has stable battery performance by employing the method for manufacturing the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 23B illustrates an example of a power storage device of one embodiment of the present invention. As illustrated in FIG. 23B, a large power storage device 791 obtained by the method for manufacturing the secondary battery of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, the demand for electric power depending on a time period (or per hour) that is predicted by the predicting portion 712 can be checked.

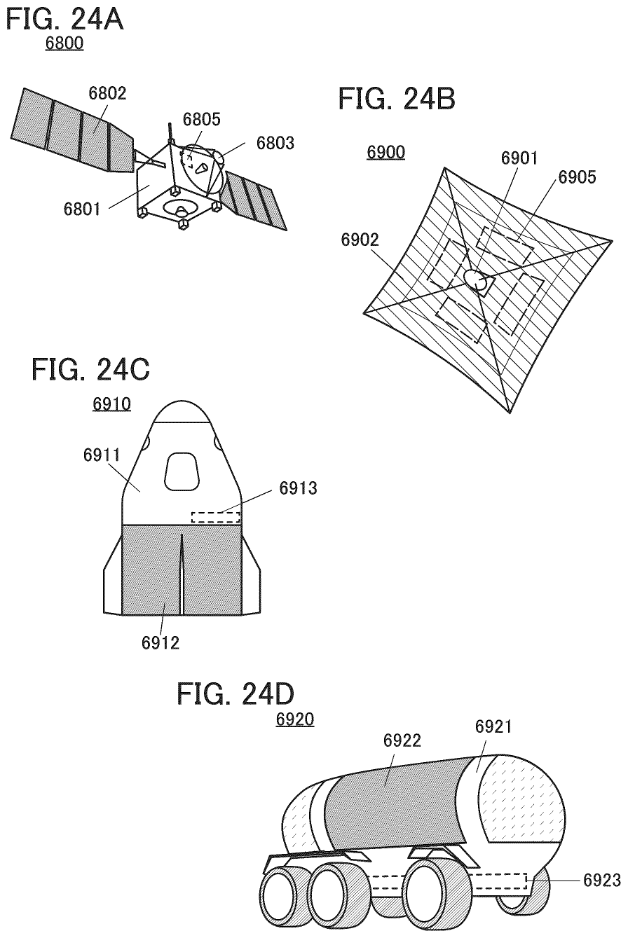

FIG. 24A illustrates an artificial satellite 6800 as an example of a device for space. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 24B illustrates a probe 6900 including a solar sail as an example of a device for space. The probe 6900 includes a body 6901, a solar sail 6902, and a secondary battery 6905. When photons from the sun are incident on the surface of the solar sail 6902, the momentum is transmitted to the solar sail 6902. Therefore, it is preferable that the surface of the solar sail 6902 have a thin film with high reflectance, and it is further preferable that the surface of the solar sail 6902 face the sun.

The solar sail 6902 folds compact before reaching the outer atmosphere, and is unfurled to have a large thin-film sheet-like shape as illustrated in FIG. 24B in the expanse beyond the earth's atmosphere (outer space). Therefore, the bendable secondary battery of one embodiment of the present invention is preferably used as the secondary battery 6905 mounted on the solar sail 6902.

FIG. 24C illustrates a spacecraft 6910 as an example of a device for space. The spacecraft 6910 includes a body 6911, a solar panel 6912, and a secondary battery 6913. The secondary battery of one embodiment of the present invention can be used as the secondary battery 6913. The body 6911 can include a pressurized cabin and an unpressurized cabin, for example. The pressurized cabin may be designed so that the crew can get into the cabin. Electric power that is generated by irradiation of the solar panel 6912 with sunlight can be stored in the secondary battery 6913. Note that the solar panel 6912 and the secondary battery 6913 may each have flexibility. The use of the solar panel 6912 having flexibility is preferable, in which case the solar panel 6912 being in a curved shape can be provided on an outer surface portion of the body 6911. The use of the secondary battery 6913 having flexibility is preferable, in which case the secondary battery 6913 being in a curved shape can be provided on the inner side of the solar panel 6912 (the inner portion side of the body 6911). As the secondary battery 6913 having flexibility, the secondary battery 10 having flexibility, which is described in FIG. 1 and the like, can be used.

FIG. 24D illustrates a rover 6920 as an example of a device for space. The rover 6920 includes a body 6921 and a secondary battery 6923. The rover 6920 may include a solar panel 6922. The secondary battery of one embodiment of the present invention can be used as the secondary battery 6923. The rover 6920 may be designed so that the crew can get into the rover. Electric power that is generated by irradiation of the solar panel 6912 with sunlight may be stored in the secondary battery 6923, or electric power generated by another power source such as a fuel cell or a radioisotope thermoelectric generator, for example, may be stored in the secondary battery 6923. Note that the solar panel 6922 and the secondary battery 6923 may each have flexibility. The use of the solar panel 6922 having flexibility is preferable, in which case the solar panel 6922 being in a curved shape can be provided on an outer surface portion of the body 6921. The use of the secondary battery 6923 having flexibility is preferable, in which case the secondary battery 6923 being in a curved shape can be provided on the inner side of the solar panel 6922 (the inner portion side of the body 6921). As the secondary battery 6923 having flexibility, the secondary battery 10 having flexibility, which is described in FIG. 1 and the like, can be used.

This embodiment can be implemented in appropriate combination with the other embodiments.

### Example 1

In this example, a secondary battery of one embodiment of the present invention was fabricated and battery performance thereof was evaluated. Here, a test cell A fabricated on the basis of the fabrication method described in Embodiment 1; a test cell B fabricated using a structure partly different from that of the test cell A; a comparative cell C; and a comparative cell D are described.

### [Formation of Positive Electrode]

The positive electrode was formed using lithium cobalt oxide as a positive electrode active material. The positive electrode active material, acetylene black (AB), and polyvinylidene fluoride (PVDF) were mixed at the positive electrode active material:AB:PVDF=95:3:2 (weight ratio) using NMP as a solvent, whereby slurry was formed. After a current collector was coated with the formed slurry, the solvent was volatilized. After that, pressing was performed with 120 kN/m at 120° C. and a positive electrode active material layer was formed on the current collector, whereby the positive electrode was formed. Aluminum foil having a thickness of 20 μm was used as the current collector. The positive electrode active material layer was provided on one surface of the current collector. The loading amount was approximately 10 mg/cm².

### [Formation of Negative Electrode]

A negative electrode was formed using graphite as a negative electrode active material.

MCMB graphite having a specific surface area of 1.5 m²/g was used as the graphite and mixed with a conductive additive, CMC-Na, and SBR at the graphite: the conductive additive:CMC-Na:SBR=96:1:1:2 (weight ratio) using water as a solvent, whereby slurry was formed.

The polymerization degree of CMC-Na that was used was 600 to 800, and the viscosity of a 1 weight % CMC-Na aqueous solution was in the range from 300 mPa·s to 500 mPa·s. As the conductive material, VGCF (registered trademark)-H (produced by SHOWA DENKO K.K., the fiber diameter: 150 nm, the specific surface area: 13 m²/g), which is vapor-grown carbon fiber, was used.

A current collector was coated with the formed slurry and then drying was performed, so that a negative electrode active material layer was formed on the current collector. Copper foil having a thickness of 18 μm was used as the current collector. The negative electrode active material layer was provided on both surfaces or one surface of the current collector. The loading amount was approximately 9 mg/cm².

### [Fabrication of Test Cell A]

Eight positive electrodes and eight negative electrodes were prepared.

The positive electrodes were used after each pair of positive electrodes was made to overlap with each other with surfaces opposite to the coated surfaces facing each other and the pair of positive electrodes was covered with a bag-like separator. As the separator, a 24-μm-thick polyimide separator was used.

Next, as illustrated in FIG. 7A, the positive electrodes covered with the separators and the negative electrodes were stacked. After that, as shown in FIG. 7C, leads were bonded to current collector exposed portions (also referred to as tab portions) of the positive electrodes and the negative electrodes by ultrasonic welding.

Next, as illustrated in FIG. 8A, a polyimide tape was attached to part of the negative electrode as an insulating film. After that, a first spacer 55 and a second spacer 56 were prepared and connected to each other using a polyimide tape as a connection portion. As the first spacer and the second spacer, a cylindrical hollow (tube-like) electron-beam crosslinked soft polyolefin resin was used.

Next, as illustrated in FIG. 8A, the tab portions of the positive electrodes and the negative electrodes were curved to overlap with the stacked portion, and the first spacer and the second spacer were provided.

In this way, the stack was completed.

Next, as illustrated in FIG. 9B, two flexible films were attached to the exterior body. A polyimide tape was used as the flexible films.

As the exterior body, an aluminum laminated film with a thickness of approximately 110 μm in which polypropylene (approximately 45 μm), aluminum foil (approximately 40 μm), and nylon (approximately 25 μm) were stacked in this order was used. As the aluminum laminated film, an embossed aluminum laminated film having projections and depressions was used, and its embossed pattern was a criss-cross pattern. The embossed aluminum laminated film was used in which the pitch of the embossed pattern was approximately 1.7 mm and the height difference between the projections and the depressions was approximately 0.5 mm.

Next, the stack was sandwiched between the exterior body, and the exterior body was sealed with the portion for injecting an electrolyte solution left as an aperture.

Next, in an argon gas atmosphere, the electrolyte solution was injected from the one side left as the aperture.

The electrolyte solution was prepared. EMI-FSA was used as a solvent of the electrolyte solution. As a lithium salt, LiFSA (lithium bis(fluorosulfonyl)amide) was used, and the concentration of the lithium salt in the electrolyte solution was 2.15 mol/L.

Then, the one side of the exterior body left as the aperture was sealed in a reduced-pressure environment. The pressure of the reduced-pressure environment measured with a differential pressure gauge was lower than or equal to −95 kPa.

Through the above steps, the test cell A was fabricated.

### [Fabrication of Test Cell B]

Next, the test cell B was fabricated. The test cell B was fabricated under the same conditions as the test cell A except that the second spacer in the test cell A was not provided. That is, the test cell B has a structure in which the tab portions of the positive electrodes and the negative electrodes are curved to overlap with the stacked portion, the first spacer 55 is provided, and the second spacer 56 is not provided.

### [Fabrication of Comparative Cell C]

Next, the comparative cell C was fabricated. The comparative cell C was fabricated under the same conditions as the test cell A except that the first spacer in the test cell A was not provided. That is, the comparative cell C has a structure in which the tab portions of the positive electrodes and the negative electrodes are curved to overlap with the stacked portion, the second spacer 56 is provided, and the first spacer 55 is not provided.

### [Fabrication of Comparative Cell D]

Next, the comparative cell D was fabricated. The comparative cell D was fabricated under the same conditions as the test cell A except that the second spacer 56 in the test cell A was not provided and the tab portions of the positive electrodes and the negative electrodes were not curved. That is, the comparative cell D has a structure in which the tab portions of the positive electrodes and the negative electrodes do not overlap with the stacked portion, the first spacer 55 is provided, and the second spacer 56 is not provided.

### [Aging]

Next, the test cell A, the test cell B, the comparative cell C, and the comparative cell D were aged.

The aging treatment was performed in the following manner: in an environment at 25° C., CC charging was performed at 0.01 C until a charge capacity reached 15 mAh/g, a 10-minute break was taken, and then CC charging was performed at 0.1 C until a charge capacity reached 105 mAh/g (120 mAh/g in total). After that, each of the cells was held for 24 hours at 60° C., the one side of the exterior body was cut open in an argon atmosphere, degassing was performed, and then resealing was performed. The resealing after the degassing was performed in a reduced-pressure environment at −95 kPa or lower (a pressure value read by a differential pressure gauge). Next, in an environment at 25° C., CCCV charging (0.1 C, a termination current of 0.01 C, 4.2 V) was performed and CC discharging (0.2 C, 2.5 V) was performed. Next, in an environment at 25° C., charging (CCCV charging (0.2 C, a termination current of 0.02 C, 4.2 V) and discharging (CC discharging (0.2 C, 2.5 V)) were repeated three times, so that the aging treatment was completed.

### [Bend Test]

Next, a repeated bend test was performed on the test cell A, the test cell B, the comparative cell C, and the comparative cell D. In the bend test, bending with a radius of curvature of 40 mm and stretching with a radius of curvature of 150 mm were repeated.

A bend tester will be described. The bend tester includes a cylindrical supporting body with a radius of curvature of 40 mm extending in the depth direction under a center portion where the secondary battery is placed. The tester also includes arms extending in the right and left directions. End portions of the arms are mechanically connected to holding plates. By moving the end portions of the arms up or down, the holding plates can be bent along the support body. The bend test of the secondary battery was performed with the secondary battery sandwiched between the two holding plates. Thus, moving the end portions of the arms up or down allows the secondary battery to be bent along the cylindrical supporting body. Specifically, lowering the end portions of the arms permits the secondary battery to be bent with a radius of curvature of 40 mm. At the position where the end portion of the arm is raised, the secondary battery is curved with a radius of curvature of 150 mm. Since the secondary battery is bent while being sandwiched between the two holding plates, unnecessary force except bending force can be prevented from being applied to the secondary battery. Furthermore, bending force can be uniformly applied to the whole secondary battery.

As the bend test conditions, bending was performed every 2 seconds. The charge and discharge characteristics were evaluated at 25° C. after the secondary battery was dismounted from the tester. The charge and discharge were performed under the conditions that the rate was 0.2C, the upper voltage limit was 4.2 V, and the lower voltage limit was 3.0 V. The measurement temperature was 25° C. Note that discharge capacity (mAh/g) is a value per unit weight of the positive electrode active material. Here, as to the rate C, 1 C corresponds to a current density per unit weight of the positive electrode active material of 135 mA/g.

Table 1 shows the results of the bend test performed on the test cell A. Table 2 shows the results of the bend test performed on the test cell B. Table 3 shows the results of the bend test performed on the comparative cell C. Table 4 shows the results of the bend test performed on the comparative cell D. The number of times of bending shown in the first columns in Table 1 to Table 4 represents the total number of times of bending in the bend test; after the total number of times of bending was reached, the cell was detached from the bend tester and a charge and discharge test was performed. The discharge capacity at this time is shown in the second columns in Table 1 to Table 4. After the charge and discharge test, the cell was attached to the bend tester again and the bend test was continued. Note that the retention rate shown in the third columns is values calculated on the assumption that the discharge capacity in the charge and discharge test performed before the bend test is 100%.

TABLE 1

| Number of | | |
|---|---|---|
| times of bending | Discharge capacity (mAh/g) | Retention rate (%) |
| Before test | 140.7 | 100.0 |
| 1000 times | 140.8 | 100.1 |
| 3000 times | 140.6 | 99.9 |
| 6000 times | 139.7 | 99.3 |
| 10000 times | 139.9 | 99.5 |
| 15000 times | 139.2 | 99.0 |
| 20000 times | 139.1 | 98.8 |
| 25000 times | 138.5 | 98.4 |
| 30000 times | 137.8 | 98.0 |
| 35000 times | 137.8 | 98.0 |
| 40000 times | 134.4 | 95.5 |
| 45000 times | 131.7 | 93.6 |
| 50000 times | 108.0 | 76.8 |

TABLE 2

| Number of | | |
|---|---|---|
| times of bending | Discharge capacity (mAh/g) | Retention rate (%) |
| Before test | 142.9 | 100.0 |
| 1000 times | 142.1 | 99.4 |
| 3000 times | 141.7 | 99.2 |
| 6000 times | 141.4 | 98.9 |
| 10000 times | 141.1 | 98.7 |
| 15000 times | 135.2 | 94.6 |
| 20000 times | 139.2 | 97.4 |
| 25000 times | 99.8 | 69.8 |
| 30000 times | 0.0 | 0.0 |

TABLE 3

| Number of | | |
|---|---|---|
| times of bending | Discharge capacity (mAh/g) | Retention rate (%) |
| Before test | 142.4 | 100.0 |
| 1000 times | 141.4 | 99.3 |
| 3000 times | 141.1 | 99.1 |
| 6000 times | 0.0 | 0.0 |

TABLE 4

| Number of | | |
|---|---|---|
| times of bending | Discharge capacity (mAh/g) | Retention rate (%) |
| Before test | 142.8 | 100.0 |
| 1000 times | 142.2 | 99.6 |
| 3000 times | 104.5 | 73.2 |
| 6000 times | 27.2 | 19.1 |

In the test cell A of this example, a rapid decrease in discharge capacity was not observed in the bend test up to the 45000th time, and a rapid decrease in discharge capacity was observed after the 50000th time in the bend test. The rapid decrease in discharge capacity in the bend test from the 45001st time to the 50000th time corresponds approximately to a decrease in the capacity of one electrode; thus, it is probable that a large deterioration (e.g., breakage of an electrode) occurred in the positive electrode lead, the negative electrode lead, the positive electrode lead connection portion (the positive electrode tab portion), the negative electrode lead connection portion (the negative electrode tab portion), and a peripheral portion thereof inside the test cell A. In other words, it is probable that a large deterioration (e.g., breakage of an electrode) did not occur in the positive electrode lead, the negative electrode lead, the positive electrode lead connection portion (the positive electrode tab portion), the negative electrode lead connection portion (the negative electrode tab portion), and the peripheral portion thereof inside the test cell A in the bend test up to the 45000th time. That is, it can be said that the test cell A, which is an example of the secondary battery of one embodiment of the present invention, was able to withstand an extremely large number of times of repeated bending as many as 45000 times.

In addition, in the test cell B of this example, a rapid decrease in discharge capacity was not observed in the bend test up to the 20000th time, and a rapid decrease in discharge capacity was observed after the 25000th time in the bend test. Accordingly, the test cell B was found to have favorable bending resistance, though it is not as favorable as that of the test cell A.

On the other hand, in the comparative cell C and the comparative cell D, a rapid decrease in discharge capacity occurred in the bend test up to the 6000th time; therefore, they were found to have low resistances to repeated bending. That is, the test cell A, which is an example of the secondary battery of one embodiment of the present invention, was able to withstand an extremely large number of times of bending compared with the comparative cell C in which the tab portions of the positive electrodes and the negative electrodes are curved so as to overlap with the stacked portion and the first spacer 55 is not provided. The test cell A, which is an example of the secondary battery of one embodiment of the present invention, was able to withstand an extremely large number of times of bending compared with the comparative cell D in which the tab portions of the positive electrodes and the negative electrodes do not overlap with the stacked portion, the first spacer 55 is provided, and the second spacer 56 is not provided.

As a result of the above-described example, it was confirmed that high resistance to repeated bending can be obtained with the structure in which the tab portions of the positive electrodes and the negative electrodes are curved to overlap with the stacked portion and the first spacer 55 is provided. It was also confirmed that significantly high resistance to repeated bending can be obtained with the structure in which the tab portions of the positive electrodes and the negative electrodes are curved to overlap with the stacked portion and the first spacer 55 and the second spacer 56 are provided.

### REFERENCE NUMERALS

10: secondary battery, 20: positive electrode, 21: positive electrode lead, 22: positive electrode current collector, 23: positive electrode active material layer, 24: positive electrode current collector exposed portion, 25: positive electrode active material coated portion, 26: connection portion, 30: negative electrode, 31: negative electrode lead, 32: negative electrode current collector, 33: negative electrode active material layer, 34: negative electrode current collector exposed portion, 35: negative electrode active material coated portion, 36: connection portion, 40: separator, 45: insulating film, 50: exterior body, 51: sealing portion, 55: spacer, 56: spacer, 57: connection portion, 58: flexible film, 59: flexible film, 60: stack, 61: stacked portion

1. A secondary battery comprising:
an exterior body enclosing a positive electrode, a negative electrode, a separator, a first spacer, and a second spacer; and a positive electrode lead and a negative electrode lead that extend from inside to outside of a space enclosed by the exterior body,
wherein the positive electrode comprises a first portion coated with a positive electrode active material and a second portion where a positive electrode current collector is exposed,
wherein the negative electrode comprises a third portion coated with a negative electrode active material and a fourth portion where a negative electrode current collector is exposed,
wherein the first portion, the third portion, and the separator overlap with each other in a stacked portion,
wherein the positive electrode lead is connected to the second portion in a position overlapping with the stacked portion,
wherein the negative electrode lead is connected to the fourth portion in a position overlapping with the stacked portion,
wherein the first spacer is in contact with the exterior body in a region surrounded by one end portion of the stacked portion, the positive electrode lead, and the negative electrode lead in a top view, and
wherein the second spacer comprises a region interposed between the stacked portion and the second portion, a region interposed between the stacked portion and the fourth portion, and a region connected to the first spacer.

2. The secondary battery according to claim 1,
wherein a height of the first spacer is greater than or equal to a sum of a height of the stacked portion, a height of the second spacer, a height of the second portion, and a height of the positive electrode lead.

3. The secondary battery according to claim 1,
wherein a height of the first spacer is greater than or equal to a sum of a height of the stacked portion, a height of the second spacer, a height of the fourth portion, and a height of the negative electrode lead.

4. The secondary battery according to claim 1,
wherein the second portion comprises a curved portion between a connection portion for the positive electrode lead and the stacked portion, and
wherein the curved portion comprises a region in contact with the second spacer.

5. The secondary battery according to claim 1,
wherein the fourth portion comprises a curved portion between a connection portion for the negative electrode lead and the stacked portion, and
wherein the curved portion comprises a region in contact with the second spacer.

6. The secondary battery according to claim 1,
wherein the first spacer and the second spacer are flexible, and
wherein the first spacer is more elastic than the second spacer.

7. The secondary battery according to claim 1,
wherein the exterior body comprises a region in contact with a flexible film on an inner surface of the space enclosed by the exterior body, and
wherein the stacked portion comprises a region in contact with the flexible film in the other end portion of the stacked portion.

8. The secondary battery according to claim 7,
wherein the flexible film is insulative.

9. The secondary battery according to claim 7,
wherein the flexible film comprises polyimide and comprises a region where the other end portion of the stack portion is in contact with the polyimide.

10. The secondary battery according to claim 1,
wherein the exterior body comprises a depression and a projection.
